(19) United States
(12) Patent Application Publication
(10) Pub. No.: US 2007/0100875 A1
(43) Pub. Date: May 3, 2007

(54) SYSTEMS AND METHODS FOR TREND EXTRACTION AND ANALYSIS OF DYNAMIC DATA

(75) Inventors: Yun Chi, (US); Belle L. Tseng, (US); Junichi Tatemura, (US)

Correspondence Address: NEC LABORATORIES AMERICA, INC., 4 INDEPENDENCE WAY, PRINCETON, NJ, 08540, US

(73) Assignee: NEC Laboratories America, Inc.

(21) Appl. No.: 11/556,091

(22) Filed: Nov. 2, 2006

Related U.S. Application Data
(60) Provisional application No. 60/733,231, filed on Nov. 3, 2005.

(51) Int. Cl. G06F 7/00

(52) U.S. Cl. 707/102

(57) ABSTRACT

The invention is directed generally to providing methods and systems for trend extraction and analysis. Embodiments include methods and systems for trend extraction and analysis of information extracted from dynamically changing data included in computer systems and/or networks. Various exemplary embodiments are provided that may generate characteristic indicators for trend(s) and/or distribution(s) for one or more data sources by use of, for example, temporal indicators derived through analysis of the difference in contribution separate portions of the data to the whole data set being considered, contribution of individual sources, and/or the interaction of the separate portions of the data with one another. Some exemplary approaches may include the use of singular value decomposition (SVD) and higher-order singular value decomposition (HOSVD) data extraction and analysis techniques. One use of these techniques is in the analysis of the dynamic data contained in Weblogs and the blogosphere.

This application claims the benefit of U.S. Provisional Application No. 60/733,231 filed Nov. 3, 2005, the entire disclosure of which is hereby incorporated by reference as if set forth fully herein.

This disclosure may contain information subject to copyright protection. The copyright owner has no objection to the facsimile reproduction by anyone of the patent disclosure or the patent as it appears in the U.S. Patent and Trademark Office files or records, but otherwise reserves all copyright rights whatsoever.

### BACKGROUND

1. Field of the Invention

The present invention relates to the field of data trends and analysis, and more specifically, to methods and systems relating to trend extraction and analysis of data located on various computer systems and network(s), for example, the Internet.

2. Description of Related Art

Data extraction and analysis of dynamically changing data compilations, including analysis of relationships in the data, trend analysis, and prediction of the future is an area of wide application. For example, individuals and organizations often would like to derive useful information from data that will help them with sales, marketing, purchase, and various operation decisions to improve the efficiency and effectiveness of their and that of the organization. Some examples of dynamically changing data includes email messages including various topics, To-Do lists on peoples computers, employee or customers postings to companies electronic bulletin boards (e.g., on a LAN, an Intranet, or the Internet), development of web sites on computer networks including the Internet, open postings to web sites such as Wikipedia, open postings to Craigslist, open postings to public bulletin boards on the Internet (e.g., weblog web sites), etc. In many cases, this dynamically changing information and data may be user/entity generated content that may be very useful. However, due to the dynamic nature of the information, it is often difficult to draw meaningful information from the data or to draw insights from the data which will prove helpful in improving efficiencies and effectiveness of individuals and organization.

One particular active area of interest in data analysis is in weblog web sites on the Internet (the accumulation of all weblog web sites (or blog for short) on the Internet or World Wide Web (i.e., the Web) may be referred to as the blogosphere). A blog is a relatively new self-publishing phenomenon on the Web that has quickly become mainstream over the past few years. A blog is a special Web site on which an individual author (a blogger) or a group of collaborating authors periodically publish articles (entries or posts). Usually the entries are posted in reverse chronological order and each entry may include a time stamp indicating the time when the entry was posted.

The world of blogs is growing rapidly. According to Technorati, one of the top blog search engines, more than 1.2 million new blog entries are created everyday. In addition, these numbers have been doubling every six months in the past three years. As an arena in which tens of millions of users share the latest information and exchange personal opinions, the blogosphere offers great commercial value and provides new business opportunities in areas such as product survey, customer relationship, marketing, employee satisfaction, competitive assessments, etc. For example, for businesses to make judicious decisions, it is important for them to track customer opinions and complaints in a timely fashion. Here the blogosphere provides free large-scale information sources from which businesses can quickly learn opinions and complaints from their customers, employees, and competitor's customers about their own products and services, as well as those of their competitors. At the same time, as a special part of the Web, the blogosphere has its unique nature and features and therefore raises many new challenges. One such unique feature is that the blogosphere is much more dynamic than traditional Web pages. For example, an announcement of a new product may instantly trigger intensive discussions in the blogosphere. Very often, it is exactly these dynamic trends that are valuable for businesses to track, understand, and predict the interests of their customers, competitors, and their competitor's customers.

There may be various links among blogs and entries in the blog. A blog page may contain links to archives of old entries. It may also contain a blogroll, a sidebar consisting of bookmarks pointing to other blog sites. In the content of an entry, there may be citation links pointing to Web sites (e.g., sources of information discussed in the entry) or other entries (written either by the same author or by other bloggers). At the end of an entry, there may be comments from other bloggers as well as “trackbacks” (i.e.,links to other bloggers who are interested in the entry).

Recently, a number of commercial blog and Web search engines have introduced services for temporal trend analysis of the blogosphere. For example, for given keywords, BlogPulse and IceRocket generate trend curves over time in terms of the percentage of blog entries that contain the keywords. For a given tag, Technorati provides curves that show the daily number of entries that adopt the tag. Google has just announced a new service called Google Trend that, for given keywords, plots the search volume and news reference volume that are related to the keywords over time for all web sites.

There also exists a growing body of literature on trend analysis of dynamically evolving data in blogs and the blogosphere. For example, there have been various studies described in technical articles that include: Q. Mei, C. Liu, H. Su, and C. Zhai, A probabilistic approach to spatiotemporal theme pattern mining on Weblogs, In Proc. of the 15th WWW Conference, 2006; J. M. Kleinberg. Authoritative sources in a hyperlinked environment. J. of the ACM, 46(5), 1999; L. De Lathauwer, B. De Moor, and J. Vandewalle. A multilinear singular value decomposition. SIAM J. on Matrix Analysis and Applications, 21(4), 2000; R. Kumar, J. Novak, P. Raghavan, and A. Tomkins., On the bursty evolution of blogspace, Proc. of the 12th WWW Conference, 2003; N. S. Glance, M. Hurst, and T. Tomokiyo, BlogPulse: Automated trend discovery for weblogs, WWW 2004 Workshop on the Webloggirng Ecosystem:Aggregation, Analysis and Dynamics, 2004; D. Gruhl, R. Guha, D. Liben-Nowell, and A. Tomkins, Information diffusion through blogspace, Proc. Of the 13th WWW Conference, 2004; J. Leskovec, J. Kleinberg, and C. Faloutsos, Graphs over time: densication laws, shrinking diameters and possible explanations. In Proc. of the 11th ACM SIGKDD Conference, 2005; X. Song, B. L. Tseng, C.-Y. Lin, and M.-T. Sun., ExpertiseNet: Relational and evolutionary expert Modeling, Int. Conf on User Modeling, 2005; B. H. Murray, Sizing the internet, White paper, Cyveillance, Inc., 2000; F. Douglis, A. Feldmann, and B. Krishnamurthy, Rate of change and other metrics: a live study of the World Wide Web, In Proc. of the USENIX Symposium on Internet Technologies and Systems, 1997; J. Cho and H. Garcia-Molina, Effective page refresh policies for web crawlers, ACM Tran. on Database Systems, 28(4), 2003; D. Fetterly, M. Manasse, M. Najork, and J. L. Wiener, A large-scale study of the evolution of web Pages, Proc. of tile 12th WWW Coniference, 2003; and A. Ntoulas, J. Cho, , and C. Olston, What's new on the Web? The evolution of the web from a search engine perspective, Proc. of the 13th WWWConference, 2004. Some examples of prior patents in the general area of trend extraction and analysis techniques include those described in U.S. Pat. No. 6,915,009, U.S. Pat. No. 5,559,940, and U.S. Application Publication 2005/0091176. However, none of these approaches provide the analysis and insights that will prove most beneficial for dynamic data, particularly data that changes dues to self-publishing be one or more persons or organizations.

The aforementioned identified systems and methods lack certain useful capabilities. For example, the systems and methods do not combine the contents and the links among data sets (e.g., blogs). Further, they typically do not include a non-probabilistic approach. Nor do they model the content and linkage changes in graph structures or focus on direct analysis of the data in order to reveal trends and other insights about the data. These approaches also fail to extract trends and patterns from ordered and structured data sets, as well as form matrices containing higher dimensional structured data to analyze data, such as the change of a graph structure with time. Further, in typical trend extraction and analysis methods and systems there is no temporal/order information. They also typically fail to include an approach where one dimension is the time line and the main purpose is to extract the main trend in this dimension.

In addition, the prior approaches can not handle higher dimensional structured data, such as the change of a graph structure with time, and thus can not draw out, sort out, identify, or decipher certain characteristics contained in the data sets that may operate in different manners from the summation or aggregation of the data set. The known techniques typically use and other traditional trend analysis methods use simple statistics, such as percentage or total count, to represent temporal trends on the given keywords. Statistics such as total count or average have statistical merit and typically only represent general tendencies. However, statistics obtained by traditional methods are aggregations and typically ignore the characteristics of individual groups of data (e.g., blogs) that published the entries. This distinction becomes important because different groups of data (e.g., blogs) may contribute to the trend differently. For example, considering blogosphere data, some blogs constantly discuss products by a specific company whereas others mention the company name occasionally (e.g., only when it is acquired by another company). Such differences in activity are not factored in by traditional methods.

Therefore, there is a need for data trend extraction and analysis methods and systems that can extract and analyze trend(s) of data from dynamic data set(s) contained in computer systems and networks in more detail so that more accuracte results and characteristics of the underlying information may be obtained and more efficient and effective use of the data can be realized for individuals and organizations.

### SUMMARY

The present invention is directed generally to providing methods and systems for trend extraction and analysis. More specifically, embodiments may include methods and systems for trend extraction and analysis of information extracted from dynamically changing data included in computer systems and/or networks. For example, the present invention may be implemented in a personal computer, on ad-hoc networks such as peer-to-peer networks, and/or on a large network of computers such as LANs, Intranets, and the Internet. The techniques may be used to analyze temporal trends in various data sets and various graph structures drawn therefrom, in such data sets including the World Wide Web generally, social communities, financial data, political data, legal data, product data, service data, etc. In any case, the present invention includes various embodiments that may generate characteristic indicators for trend(s) and/or distribution(s) for one or more data sources by use of, for example, temporal indicators derived through analysis of the difference in contribution separate portions of the data have to the whole data set being considered, contribution of individual sources, and/or the interaction of the separate portions of the data with one another. Some exemplary approaches may include the use of singular value decomposition (SVD) and higher-order singular value decomposition (HOSVD) data extraction and analysis techniques. One particularly interesting exemplary use of these techniques is in the analysis of the dynamic data contained in the Web and Weblogs. In various embodiments, the dynamically changing information and data may be userlentity generated content and/or self published information.

In addition, the disclosed techniques can provide information not available through existing methods, for example, by providing the distribution of the occurrence of particular information in separate portions of the data or separate data sets. As an example, the techniques may be used to determine the distribution for the popularity of a product name or the authority of a particular entity. Further, the invention may indicate in what degree a product name is popular in the public based on the aggregate of data analysis for a complete data set (e.g., the blogosphere). In other words, the invention may help determine if a product name is popular in the general public or in a small community of blogs that share special interests. The invention may also help determine if there is an abnormal change in the structure of a data set or separate sections of a data set, for example, an abnormal change in the structure of a product-related community.

In the present description the term “eigen-trends,” may be defined to be temporal indicators derived through singular value decomposition (SVD) and higher-order singular value decomposition (HOSVD), that take differences among individual data sets or separate portions of a data set (e.g., blogs) into consideration and/or relationships among the individual data sets or separate portions of a data set. Two types of eigen-trends are described: (1) scalar eigen-trends (SVD based) and (2) structural eigen-trends (HOSVD based). In various embodiments, the systems and methods represent the observed data as a combination of information that captures temporal changes of the underlying data (i.e., eigen-trends) and information that captures the characteristics of individual data sources (e.g. bloggers) that may be referred to as the authority and/or hub. A combination statistically may give an optimal estimation of the observed data.

Various embodiments may include methods and systems in which information is partitioned into time windows. Further, some embodiments may include methods and systems in which a feature vector is built to represent the distribution of a term(s) used in a term search of one or more data source(s). Still some embodiments may include, for example, methods and systems in which a matrix(ces) is created by arranging the feature vector(s) in the order of time. Some embodiments may further include methods and systems that apply a singular value decomposition (SVD) to the matrix(ces). Various embodiments may also be directed toward generating a trend based on how a term(s) changes with time among one or more data source(s) from an output of the singular value decomposition (SVD). In various embodiments, the method(s) and system(s) may include generating a distribution vector based on how a term(s) is distributed among one or more data source(s) from an output of the singular value decomposition (SVD).

In various embodiments, a higher-order singular value decomposition (HOSVD) may be applied for trend analysis of data sets, and more particularly to trend analysis of graph structure data extracted from dynamic data. Further, the method(s) and system(s) may include a tensor (three dimensional matrix) created by arranging feature matrix(ces) in tie dimension of time. Some embodiments may include methods and systems in which a higher-order singular value decomposition (HOSVD) is applied to the tensor. Still some embodiments may further include, for example, methods and systems in which a trend(s) is generated based on how a term(s) changes with time for relationships among one or more individual data source(s) or separate portions of a data set from an output of the higher order singular value decomposition (HOSVD). In at least one embodiment, the method(s) and system(s) may include a distribution vector(s) generated based on how a term(s) is distributed among one or more data source(s) from an output of the higher order singular value distribution (HOSVD).

In various embodiments, the method(s) and system(s) may include analyzing, generating and/or identifying the temporal trend in a group of blogs with common interests, that takes the differences among individual blogs in consideration. Further, some embodiments may include methods and systems in which the observed data is a combination of information that captures temporal changes of the underlying data (i.e., eigen-trends) and information that captures the characteristics of individual bloggers (e.g., authority, hubs, etc.).

In various embodiments, the method(s) and system(s) may utilize singular value decomposition (SVD) to extract multiple scalar eigen-trends. Some embodiments may include methods and systems in which the main scalar eigen-trend best approximates the observed data and has good statistical properties. Still some embodiments may further include, for example, methods and systems in which secondary scalar eigen-trends can be used to represent non-dominating interests in the blocosphere. Further, in various embodiments, the method(s) and system(s) may utilize higher-order singular value decomposition (HOSVD) to extract structural eigen-trends. Some embodiments may include methods and systems in which structural eigen-trend(s) detect(s), for example, structural changes in the blogosphere.

The new data trend analysis and extraction techniques can reveal a lot of interesting trend information and insights for various dynamic data set(s), and as shown herein this is true for blogosphere data. These insights are not obtainable from traditional count-based methods of data trend analysis and extraction. Therefore these new techniques can provide invaluable analysis and may be particularly useful when used along with various traditional methods for trend analysis.

The above summary is intended to provide examples of the present invention and is not all inclusive. As such, the above described features of the invention and still further features included for various embodiments will be apparent to one skilled in the art based on the study of the following disclosure and the accompanying drawings thereto.

### BRIEF DESCRIPTION OF THE DRAWINGS

The utility, objects, features and advantages of the invention will be readily appreciated and understood by those skilled in the art upon consideration of the following detailed description of the embodiments of this invention, when taken with the accompanying drawings, in which same numbered elements are identical and:

FIG. 1 is an exemplary data trend extraction and analysis system, according to at least one embodiment;

FIG. 2 is an exemplary method for data trend extraction and analysis, according to at least one embodiment;

FIG. 3a is an exemplary diagram showing data results used for building a score vector-time matrix containing stacked popularity scores for blogs at different time intervals, according to at least one embodiment;

FIG. 3b is an exemplary chart depicting a score vector-time matrix containing stacked popularity scores for the blogs at different times, according to at least one embodiment;

FIG. 4 is another exemplary data trend extraction and analysis system, according to at least one embodiment;

FIG. 5 is another exemplary method for data trend extraction and analysis, according to at least one embodiment;

FIG. 6 is an exemplary diagram showing blogs at various nodes and edges at various times as they dynamically change that may be used for building an adjacency matxix-time tensor for blogs at different time intervals, according to at least one embodiment;

FIG. 7 is an exemplary diagram showing an adjacency matxix-time tensor for blogs at different time intervals, according to at least one embodiment;

FIG. 8 is another exemplary method for data trend extraction and analysis, according to at least one embodiment;

FIGS. 9a-9d are exemplary graphs depicting experimental results which illustrate what happens when a few blogs dominate the discussion on a topic in the blogosphere then, at a time point, one of the dominating blogs generates much fewer entries than usual, according to at least one embodiment;

FIGS. 10a-10d are exemplary graphs depicting experimental results which illustrate what happens when one non-dominating blog posts an abnormally large number of entries, according to at least one embodiment;

FIGS. 11a-11f are exemplary graphs depicting experimental results simulating two distinct groups of blogs discussing different aspects of the same term following different temporal patterns, according to at least one embodiment;

FIG. 12a-12d are exemplary graphs depicting experimental results which illustrate what happens when, at a given time, instead of using the hub and authority scores, all links are generated randomly by selecting any blog to be the source or the target, according to at least one embodirnent;

FIG. 13a-13d are exemplary graphs depicting experimental results which illustrate that, to become a valid hub, a blog must build a track record of consistently pointing to good authorities over time, according to at least one embodiment;

FIGS. 14a-14f are exemplary graphs depicting the scalar eigen-trend analysis for the term “tax,” according to at least one embodiment;

FIGS. 15a-15f are exemplary graphs depicting the scalar eigen-trend analysis for the term “hurricane,” according to at least one embodiment;

FIGS. 16a and 16b are exemplary graphs depicting experimental results which illustrate the authority vectors for two terms, Engadget and Technorati, suggesting that Engadget is popular in a relatively small community of bloggers while Technorati is popular in the more general public, according to at least one embodiment;

FIG. 17 are exemplary graphs depicting experimental results which illustrate the eigen-trend analysis for the term Technorati, which is the name of a top blog search company, according to at least one embodiment;

FIG. 18 is an exemplary illustration showing that Technorati is discussed among more of the general public and a distinct series of dots which represent many links pointing to a single blogger during week 4, according to at least one embodiment;

FIG. 19 is an exemplary block diagram for a computer, according to at least one embodiment; and

FIG. 20 is an exemplary block diagram of a network, according to at least one embodiment.

### DETAILED DESCRIPTION

The present invention applies generally to methods and systems for trend extraction and analysis. More specifically, embodiments may include methods and systems for trend extraction and analysis of information extracted from dynamically changing data that may be typically stored, processed, and transmitted in computer systems and/or networks. For example, the techniques described herein may be implemented in a personal computer, on ad-hoc networks such as peer-to-peer networks, and/or on a large network of computers such as LANs, Intranets, and the Internet. They may be used to analyze temporal trends in various data set(s) and various graph structures drawn from the data set(s) and related to, for example, the World Wide Web (www), social communities, financial data, political date, product data, service data, etc. The various embodiments of the invention may include methods and/or systems that generate characteristic indicators for trend(s) and/or distribution(s) for one or more data sources by use of, for example, temporal indicators derived through analysis of the difference in contribution of separate portions of the data to the whole data set being considered, contribution of individual sources, and/or the interaction of the separate portions of the data with one another. Some exemplary approaches may include the use of singular value decomposition (SVD) and higher-order singular value decomposition (HOSVD) data extraction and analysis techniques. Some particularly interesting exemplary that will be used herein to more fully describe the invention, are the techniques use in the analysis of the dynamic data contained in self publishing inter-person posting sites.

In this detailed description, Web logs and the blogosphere will be used as an example of a particular application for the present invention. In this case, blog(s) will be used for the data set(s) to be analyzed, so that a more focused understanding of the invention may be drawn. However, the invention is equally applicable to other data set(s) including dynamically changing data.

As with other data set(s) and applications, existing approaches for analyzing blog(s) are typically based on simple counts, such as the number of entries or the number of links. However, the present invention introduces a number of new techniques for trend analysis that are defined and coined herein as “eigen-trend(s)” that may be applied to various data set(s). With respect to blogs, these techniques may, for example, include representing the temporal trend in a group of blogs with common interests. There are two particular techniques for extracting “eigen-trends” in various data set(s), such as blog(s); one trend analysis technique based on the singular value decomposition (SVD) and another trend analysis based on higher-order singular value decomposition (HOSVD). The SVD extracted eigen-trend(s) may provide, for example, new insights into multiple trends on the same term or keyword. The HOSVD trend analysis technique may analyze the data set(s), such as blog(s), as a dynamic graph structure and may extracts eigen-trends that reflect the structural changes of the various data set(s), such as blog(s) in the blogosphere, over time. Experimental results show that the new techniques of the present invention can reveal a lot of interesting trend information and insights about various dynamic data set(s), and particularly with respect to blog(s), that are not presently obtainable from traditional count-based methods.

By summing up the occurrence of entries, traditional methods of analyzing blog(s) typically ignore individual blog(s) that published those entries. However, different blog(s) may contribute to the trend differently. For example, some blog(s) may constantly discuss one or more products by a specific company, whereas other blog(s) may mention the company name occasionally (e.g., only when it is acquired by another company). Such differences in activity are not factored in by traditional methods. The present invention data set(s) trend analysis and extraction techniques provide a better way to represent the temporal behavior of various blog(s) in the blogosphere by considering such differences among blog(s). Further, for the same term or keyword, different groups of blog(s) may have different interests. Sometimes, a single trend does not make sense to all the interested groups of blogs. For example, there may be some data set(s) or blog(s) that are interest in tax matters from the financial point of view and there may be other data set(s) or blog(s) that are interested in tax matters from a political point of view. Thus, if only a simple count or statistical trend analysis is provided for a “tax” software company, the trend curve, which would be an accumulation of all the interests, will be misleading for purposes such as supporting marketing decisions because at various times the blog(s) activity will be high due to political discussions about tax. Thus, the blog(s) in the blogosphere usually do not explicitly indicate its interests (e.g., finance vs. politics for tax matters). However, the present invention may be used to detect different data set(s) or blog(s) with different interests and extract meaningful trends related to the corresponding groups so that a more accurate understanding of the data may be obtained, for example, by using a technique including SVD or an equivalent analysis.

Various dynamic data set(s), including blog(s) in the blogosphere, may make up one or more ecosystem(s) in which, for example, the data set(s) such as blogs interact with each other generating reference structure. In this sense, the data set(s) or blog(s) in the blogosphere, can be considered as a data set(s) graph or blog graph where the nodes are individual data set(s) or blog(s) and the links reflect endorsements and interactions among the data set(s) or blog(s). In addition, such a data set graph or blog graph is changing with time as a result of the development of internal relationships (e.g., interactions among the data set(s) or blog(s)) and external events (e.g., breaking news). The present invention can directly analyze and extract meaningful trends from such a dynamically changing data set(s) or blog(s) graph structure(s), for example, by using a technique including HOSVD or a similar technique.

In at least one embodiment, a key idea of the present invention is to represent the observed data as a combination of information that captures temporal changes of the underlying data (i.e., eigen-trends) and information that captures the characteristics of individual user(s)/entity(ies), such as individual bloggers (e.g., authority). This combination may statistically give an optimal estimation of the observed data. As mentioned above, there may be two types of eigen-trends: which may be further coined as “scalar eigen-trenads” and “structural eigen-trends”, which are some exemplary methods for analyzing the temporal aspects of data set(s). First, the various embodiments may include a method based on the singular value decomposition (SVD) to extract multiple scalar eigen-trends. A main scalar eigen-trend may best approximate the observed data and have good statistical properties. A secondary scalar eigen-trends may be used to represent non-dominating interests in the data set(s), such as blog(s) in the blogosphere. Second, the various embodiments may include a method based on a higher-order singular value decomposition (HOSVD) to extract structural eigen-trends. The structural eigen-trend may detect the structural changes in the data set(s), such as blog(s) in the blogosphere. Although SVD may have been used for time-series analysis in various other areas, it has not been used as is done by the present invention and has not been used for trend analysis dynamic data set(s) including self publishing and/or blog(s). Further, the present invention is the first time that higher-order singular value decomposition has been used for trend analysis of graph structure data. The present data set(s) trend analysis techniques can reveal a lot of interesting trend information and insights into the characteristics of the data set(s) such as blog(s) in the blogosphere, which are not obtainable from traditional count-based methods, and it may be particularly useful in supplementing traditional methods for trend analysis.

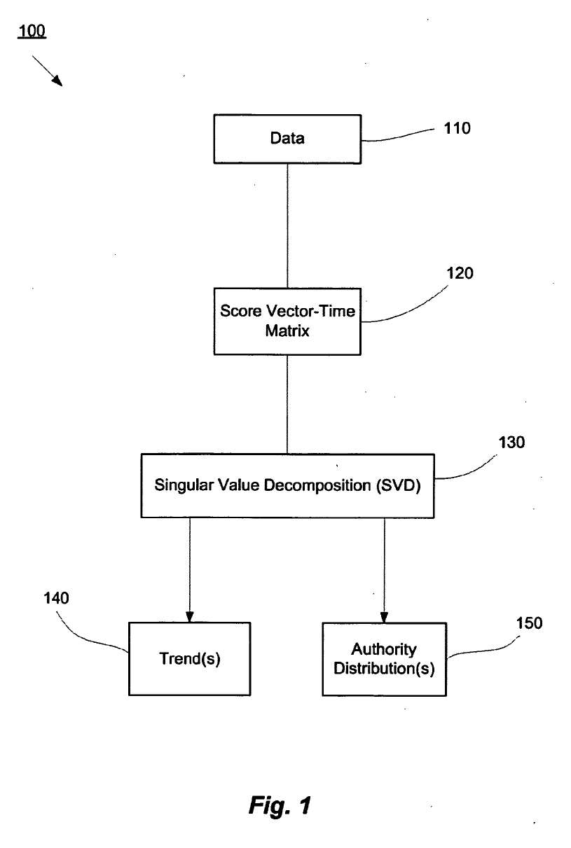

Referring now to FIG. 1, an exemplary data trend extraction and analysis system 100 is provided, according to at least one embodiment of the present invention. A data module 110 may be provided. The data module 110 may identify, obtain and/or maintain one or more data set(s) that are to be analyzed. For example, the data module 110 may include Internet or other addresses where one or more data set(s) are located and may obtain the data from that location. The data module 110 may also store that data set(s) for analysis or obtain and analyze the data from the data set(s) in real time with or without storing the data. As noted above the data may be dynamically changing and may be related to any one of numerous possible subject matters, topics, organizations, web site locations, etc., that is of interest to a user. For exemplary purposed, as described in more detail below, the present invention has been applied to analyzing data found in blog(s) on the Internet.

The data module 110 may be coupled to a Score Vector-Time Matrix module 120. The Score Vector-Time Matrix 120 may be used to build a score vector-time matrix of one or more characteristics of a data set(s). For example, a popularity or authority score of a desired entity and/or term may be calculated and placed into a score vector-time matrix generated by the Score Vector-Time Matrix 120. The Score Vector-Time Matrix 120 may be coupled to a Singular Value Decomposition (SVD) module 130. The Singular Value Decomposition (SVD) module 130 may be used to analyze the score vector-time matrix so as to determine various trends and unique characteristics of the data within the trends and over time. As such, the SVD module 130 may output various indicators such as vectors. These indicators may be used to provide for the data Trend(s) 140 nd Authority Distribution(s) 150. For example, the Trend(s) 140 may be a showing of how the popularity of a term or the occurrence of a term changes over time. Further, the Authority Distribution(s) 150 may provide a showing of how the contribution (to the total data set) of entity(ies) that make a contribution(s) to the data set may change over time.

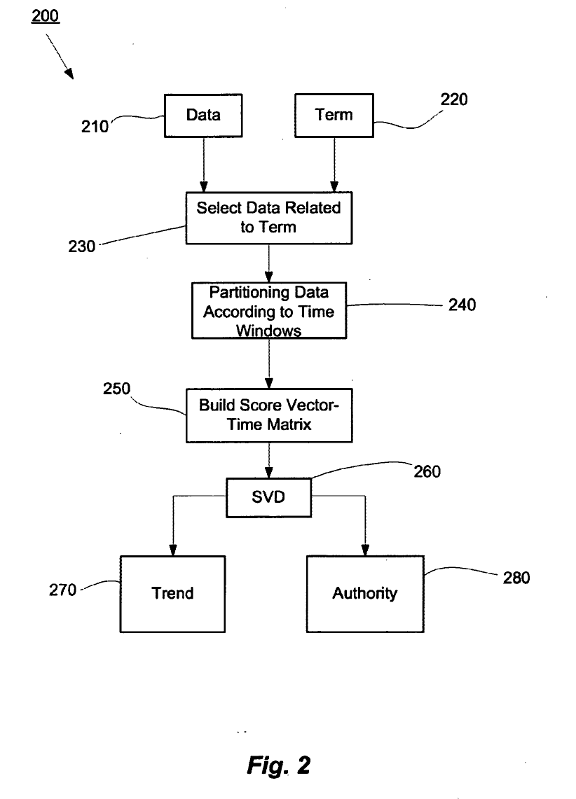

Referring now to FIG. 2 is an exemplary method for data trend extraction and analysis 200, according to at least one embodiment. In this embodiment, at 210 data from a data set(s) and at 220 a term(s) (e.g., a keyword) selection made by, for example, a user(s)/entity(ies) may be provided. Then at step 230, data from the data set(s) may be selected as data related to the term(s). Next, at step 240, the data selected related to the term may be partitioned according to time windows. Further, at step 250, a score vector-time matrix may be build from the data partitioned according to time windows. Then at step 260, a singular value decomposition (SVD) may be used to process the time windows to produce at step 270 a representation of an overall trend factor and at step 280 an authority factor that represents the contribution of one or more individual user(s)/entity(ies). For example, the trend factor may be a trend vector representing the overall trend(s) over time and the authority factor may be a vector that representing the contribution of the individual user(s)/entity(ies), as will be explained in more detail below with respect to bolg(s).

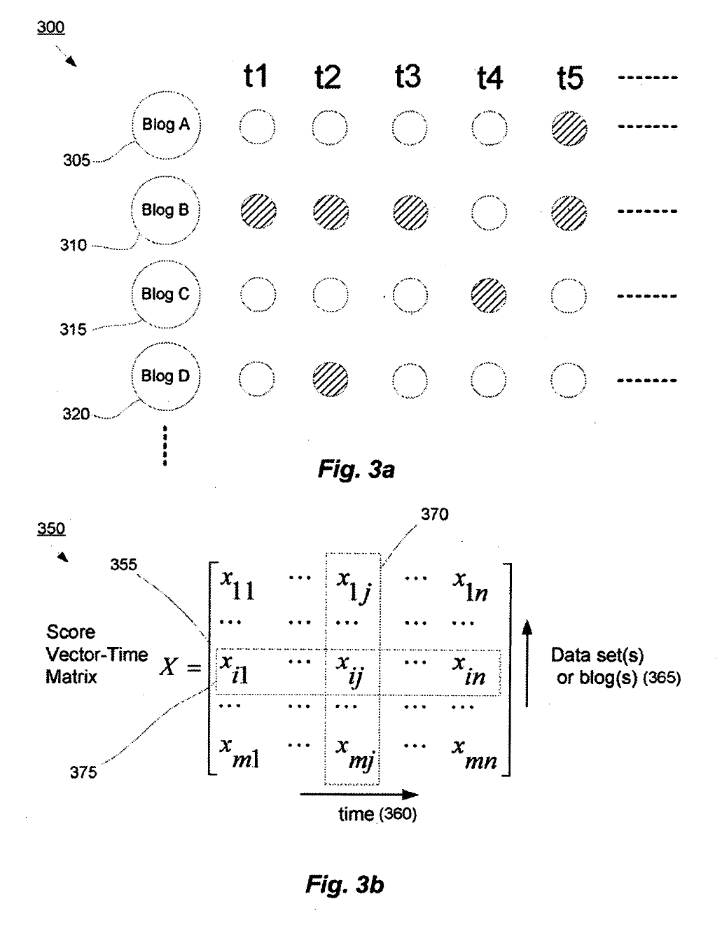

Referring now to FIG. 3a, an exemplary diagram 300 showing data results used for building a score vector-time matrix containing stacked popularity scores for blog(s) at different time intervals is provided, according to at least one embodiment. As shown hear conceptually, it is possible that one or more user(s)/entity(ies) may be a constant contributor and thus be recognized as a dominating contributor or an authority on a particular topic(s)/term(s). As can be seen by this example, in each of times t1, t2, t3, and t5, Blog B 310 has an entry with the desire term or keyword found in it, as indicated by the cross-hatched circle. However, each of Blog A 305, Blog C 315, and Blog D 320 each have only a single incident of the term or keyword found in it, as indicated by each having only a single circle with cross-hatching in it for times t1-t5. Using a simple time series and statistics the range for each time period is from 1 to 2 incidents and the average is between 1 and 2, thus the dominating contributor characteristic of Blog B 310 would be difficult to determine. However, the system and method provided in FIGS. 1 and 2 can provide this insight by doing comparative temporal analysis of the relative activities of the various Blog(s). Such characteristics of the data set(s) may be identified by utilizing a score vector-time matrix, as will be described in more detail below with reference to FIG. 3b. In various embodiments, the present invention may then use a means to extract main temporal trend information and information about the structure changes from historic structured dynamic data, for example, by using singular value decomposition (SVD).

Referring to FIG. 3b is an exemplary chart 350 depicting a score vector-time matrix 355 containing stacked popularity or authority scores for the data set(s) or blog(s) at different times, according to at least one embodiment. In this example, the x-axis 360 is time and the y-axis 365 is data set(s) or blog(s). The j^{th} column 370 represents the popularity or authority score distribution, x₁ⱼ . . . xₘⱼ, of all the data set(s) or blog(s) in time window j and the i^{th} row 375 represents the popularity or authority scores, xᵢ₁ . . . Xᵢₙ, of data set or blog bᵢ over all the time windows. As such, the data from the data set(s) is analyzed in a manner conducive to showing which user(s)/entity(ies) have a dominant characteristic. In one embodiment, this may be applied on a score vector-time matrix 350, according to the following formula: X=A=UΣV^{T} where U, V are orthogonal matrices, U=(u1, . . . , um), V=(v1, . . . , vn), Σ=diag(σ1, . . . , σk, 0, . . . , 0) is a diagonal matrix with singular values. Further, σ1v1 may be used to represent trends and u1 may be used to represent general popularity distribution. The main reason is that σ1 u1 v1′ may be the best rank-1 matrix approximating X. A detailed exemplary embodiment of how this matrix and the SVD may operate follows.

First, as background, some mathematical notations and concepts are now provided that will be used in later sections. Herein, scalars are written as lower-case letters (a,b, . . .), vectors as lower case letters in vector forms (\vec{a},\vec{b}, . . .), matrices and tensors as capital letters. One exception is made: Iₙ is used to denote the upper bound for the nth index of a tensor. For an Nth-order tensor Aε [symbol] ^{I}^{₁}^{x . . . xI}^{_{N}}, (A)ᵢ_{₁}_{. . . i}_{_{N}} is used to represent the element of A whose index of the first dimension is i¹, . . . , and index of the Nth dimension is i_{N}. As a special case, for a matrix Aε [symbol] ^{m×n}, (A)ᵢⱼ represents the element at the ith row and jth column of A. For a vector \vec{v}=(v₁, . . . , vₙ)^{T}, its 1-norm is defined as

$${‖ \vec{v} ‖}_{1} ≡ {\sum }_{i = 1}^{n} \vert {v}_{i} \vert$$

and its 2-norm is defined as

$${‖ \vec{v} ‖}_{2} ≡ \sqrt{{\sum }_{i = 1}^{n} {\vert {v}_{i} \vert}^{2}} .$$

The 2-norm of a matrix Aε [symbol] ^{m×n} is defined based on the vector 2-norm as ∥A∥₂≡max_{∥\vec{v}∥}_{²}₌₁∥A\vec{v}∥₂. A square matrix Aε [symbol] ^{m×m} is called an orthogonal matrix if AA^{T}=A^{T}A=I, where I is the identity matrix in [symbol] ^{m×m}.

Further, for two tensors A, Bε [symbol] ^{I}^{₁}^{x . . . xI}^{_{N}}, the scalar product of A and B is defined as

$$〈 A , B 〉 ≡ {\sum }_{{i}_{1} = 1}^{{I}_{1}} ⋯ {\sum }_{{i}_{N} = 1}^{{I}_{N}} {( A )}_{{i}_{1} ⋯ {i}_{N}} {( B )}_{{i}_{1} ⋯ {i}_{N}} . \\ A and B are said to be orthogonal if 〈 A , B 〉 = 0.$$

Finally, the Frobenius norm of A is defined as ∥A∥_{F}≡\sqrt{<A, A>}.

Given that background, for a given term or keyword (e.g., the name of a specific product), trend analysis studies according to the present invention may be applied to blog(s) to show a term(s) dominance, popularity or authority in blog(s) of the blogosphere as it changes over time. For example, the blog(s) of a blogosphere may consists of m blogs and that the popularity or authority score of a term(s) or keyword(s) k among those blog(s) within a time window j is given as a dominance, popularity or authority vector \vec{x}ⱼ=(x₁ⱼ, . . . , xₘⱼ)^{T}. This dominance, popularity or authority vector may be observed through n consecutive time windows and stacked into an m×n matrix X=(\vec{x}₁, . . . , \vec{x}ₙ), as illustrated in FIG. 3b. Note that this discussion is independent of how the dominance, popularity or authority score is derived. For example, xᵢⱼ may be the number of entries by blog i that contains a term or keyword k, at, for example, time j. Given a term or keyword k, a trend vector \vec{t}=(t₁, . . . , tₙ)^{T} may be found that represents the temporal aspect of the observed dominance, popularity or authority score(s) X, where tⱼ represents the overall dominance, popularity or authority score at time j.

The observed data X may be represented by a pair of vectors: a trend vector \vec{t} that represents the overall trends of a term or keyword over time and an authority vector \vec{a} that represents the contribution of individual entity(ies), e.g, bloggers, to the trend. The following mathematical formulation may be used to show that this pair of vectors can provide better statistic estimation of the observed data X compared to traditional count-based methods. Accordingly, in at least one embodiment of the present invention, a new temporal trend, called a scalar eigen-trend, is proposed.

First, it may be observed how well traditional count-based methods can represent the observed data X. A simple count-based method may represent the trend as a vector \vec{t}_{c}=(t₁, . . . , tₙ)^{T} where tⱼ=Σᵢxᵢⱼ. That is, the overall popularity score at time j may be defined as the total number of entries among all data set(s), e.g., blogs, at time j that contain the term or keyword. This count-based score may be a reasonable estimator of the central tendency of the popularity among blogs and is particularly useful in the following sense—if it is assumed that at time j, each xij is an independent sample drawn from a random variable with mean

$$\frac{1}{m} μ ,$$

then \hat{μ}=tⱼ=Σᵢxᵢⱼ is an unbiased estimator for μ that has the minimal sample variance

$${\sum }_{i} {( {x}_{ij} - \frac{1}{m} μ )}^{2} .$$

To represent this property in a different way, the vector \vec{t}_{c} may be the solution to the following equation:

$${\vec{t}}_{c} = {arg min}_{ {\vec{t}}_{1} } {‖ X - {\vec{a}}_{o} \cdot {\vec{t}}_{1}^{T} ‖}_{F} \qquad ( 1 )$$

where ∥·∥_{F} is the Frobenius norm and \vec{a}ₒ is a column vector whose entries are all 1/m.

Note however that in the above discussion and trend analysis, differences among individual blogs are ignored and it is assumed that the popularity score of any blog has the same distribution as the sum of the total blogs. That is, in the count-based score may be a reasonable estimator without knowledge of the influence on the total of individual entity(ies), such as individual bloggers, a priori. In reality, however, it may be observed that one entity, e.g., a blogger, may publish entries on the term or keyword more frequently than other entity(ies) or blogger(s), contributing to the number of overall occurrences of the term or keyword (i.e., trend) constantly, thus becoming a dominant, popular or authority entity(ies) or blogger(s). For example, for the term or keyword “iPod,” there can be data set(s) or blogs devoted completely to iPod that have tens of entries every day talking about different features of iPod, and there can also be data set(s) or blogs that mention iPod only infrequently. Assuming that the fraction of contribution to the trend by individual entity(ies) or bloggers, xᵢⱼ, is drawn from a distribution with aᵢμ as the mean. This information may be given as a unit 2-norm vector \vec{a}=(a₁, . . . , aₘ)^{T}. Under this assumption, a better trend indicator may be given as μ that minimizes the error Σᵢ(xᵢⱼ−aᵢμ)² instead of the error

$${\sum }_{i} {( {x}_{ij} - \frac{1}{m} μ )}^{2}$$

as used in the count-based method. Then, the trend \vec{t} may be the solution to the following equation:

$$\vec{t} = {arg min}_{ {\vec{t}}_{1} } {‖ X - \vec{a} \cdot {\vec{t}}_{1}^{T} ‖}_{F} \qquad ( 2 )$$

In fact, the following property may show that under an assumption of equal variance, the solution that minimizes Σᵢ(xᵢⱼ−aᵢμ)² is the linear unbiased estimator for μ with the minimal variance. Property 1. Let \vec{a}₌₍ₐ₁, . . . , aₘ)^{T} be a unit vector. If for each i, xᵢⱼ is drawn from a distribution with mean μ and variance σ², then the value \hat{μ}=arg minᵣ Σᵢ(xᵢⱼ−aᵢr)² is the linear unbiased estimator for μ with the minimal variance. By setting the derivative of Σᵢ(xᵢⱼ−aᵢr)² with respect to r to be zero, the value that minimizes Σᵢ(xᵢⱼ−aᵢr)² is \hat{μ}=Σᵢaᵢxᵢⱼ. \hat{μ} may be an unbiased estimation of μ because E(\hat{μ})=E(Σᵢaᵢxᵢⱼ)=Σᵢaᵢ²μ=μ. Now we prove that \hat{μ} may be the linear unbiased estimator for μ with the minimal variance. For an arbitrary linear estimator \hat{μ}₁ for μ, then \hat{μ}₁ may be Σᵢbᵢxᵢⱼ and define \vec{b}=(b₁, . . . , bₘ)^{T}. For \hat{μ}₁ to be unbiased, we have E(\hat{μ}₁)=E(Σᵢbᵢxᵢⱼ)=(Σᵢbᵢaᵢ)μ and so Σᵢbᵢaᵢ=1 or equivalently
∥\vec{b}∥·∥\vec{a}∥·cos θ=1
where θ is the angle between \vec{b} and \vec{a}. The variance of \hat{μ}₁ may be written as
var(\hat{μ}₁)=var(Σᵢbᵢxᵢⱼ)=(Σᵢbᵢ²)σ²=∥\vec{b}∥² σ²
So it would be desirable to minimize ∥\vec{b}∥² σ² subjected to ∥\vec{b}∥·∥\vec{a}∥·cos θ=1. Because ∥\vec{a}∥=1, the solution is obviously θ=0 and \vec{b}=\vec{a}. Therefore, \hat{μ}=Σᵢaᵢxᵢⱼ may be the linear unbiased estimator for μ with the minimal variance.

Now, we may determine how to best estimate \vec{a}. A simple way may be to take the average of xᵢⱼ over all the time windows. However, this estimation treats all the time windows equally. Similar to the above discussion, if the trend for each time window is known, a better way to estimate may be to find \vec{a} that minimizes the error Σᵢⱼ(xᵢⱼ−aᵢtⱼ)². Note that \vec{t} may be one example of a desired trend. Then the trend \vec{t} may be given by the following equation:

$$\vec{t} = {arg min}_{ {\vec{t}}_{1} } ( {min}_{‖ {\vec{a}}_{1} ‖ = 1} {‖ X - {\vec{a}}_{1} \cdot {\vec{t}}_{1}^{T} ‖}_{F} ) \qquad ( 3 )$$

That is, a pair of \vec{t} and \vec{a} may be provided, that together best approximate the observed data.

Equation (3) above may be solved by, for example, applying a singular value decomposition (SVD) on X: a Theorem 1 may be to assume X=UΣV^{T} is the singular value decomposition for X, where U=(\vec{u}₁, . . . , \vec{u}ₘ)ε [symbol] ^{m×m} and V=(\vec{v}₁, . . . , \vec{v}ₘ)ε [symbol] ^{m×n} are orthogonal matrices representing the basis for the column space and the basis for the row space of X, respectively; Σ=diag(σ₁, . . . , σₖ, 0, . . . , 0)ε [symbol] ^{m×n} in which k≦min(m, n) is the rank of X and σ₁≧ . . . ≧σₖ≧0 are the singular values of X. Then σ₁\vec{v}₁ is a solution to \vec{t} in Equation (3) and the minimal error is achieved at \vec{a}₁=\vec{u}₁. A proof of the theorem may be that the theorem may be obtained from the following well-known property of an SVD: with σ₁, \vec{u}₁ and \vec{v}₁ being the first singular value, the first left and right singular vectors, respectively, if we define X₁=\vec{u}₁σ₁\vec{v}₁, then ∥X−X₁∥_{F}=min_{rank(Y)=1}∥X−Y∥_{F}. Obviously \vec{a}₁\vec{t}₁^{T} is a rank-1 matrix with ∥\vec{a}∥=1. So by taking \vec{t}₁=σ₁\vec{v}₁ and \vec{a}₁=\vec{u}₁, Equation (3) may be satisfied. Of course, there may be other methods that may prove equally useful in indicating the dominance, popularity, or authority of an entity(ies) or blogger(s) in the data or information contained in the data set(s) or blog(s).

The above discussion shows that the pair of vectors, \vec{t} and \vec{a}, may be better indicator(s) to approximate the characteristics of the observed data, where the former shows the temporal trend of the popularity of a term or keyword and the latter shows the contribution to the whole or dominance of individual entity(ies) or blogger(s) to the trend. These are defined or identified herein as an eigen-trend and an authority scores, respectively. To distinguish this group of trend indicators from another group of trend indicators discussed later, this group of trend indicators will specifically be called a scalar eigen-trend. These names are particularly appropriate given because of the following property: Property 2. It may be shown that tie solutions \vec{a} and \vec{t} from the above procedure may satisfies the following recursive relationship (after appropriate normalization)

$$\begin{matrix}\{ \begin{matrix}\vec{t} = {X}^{T} \vec{a} \\ \vec{a} = X \vec{t}\end{matrix} & & or & & \{ \begin{matrix}{t}_{j} = {\sum }_{i} {x}_{ij} {a}_{i} \\ {a}_{i} = {\sum }_{j} {x}_{ij} {t}_{j}\end{matrix}\end{matrix} \qquad ( 4 )$$

This mutual reinforcement relationship between \vec{t} and \vec{a} may be considered as similar to the one between hubs and authorities in an HITS algorithm. In at least one embodiment of the present invention, an a data set or blog i that has a high score aᵢ can be seen as an authority in a sense that the entity or blogger may better represents the trend. The overall popularity tⱼ at time j may be high when it is base on the contribution of many good authority data set(s) or blogs, and a good authority data set or blog must contribute to the popularity when the overall popularity tⱼ is high. The scalar eigen-trend and authority scores may also have the following properties: Property 3. If all elements of X are non-negative, then the singular value decomposition can be written in such a way that all elements of \vec{u}₁ (and therefore \vec{a}) arid \vec{v}₁ (and therefore \vec{t}) are non-negative. Property 3 may guarantee that \vec{a} and \vec{t} will be non-negative. This may be helpful because \vec{t} may be used to represent the temporal trend and \vec{a} to represent the authority score, and it may be difficult to interpret negative values in either of them. It is worth noting that all elements of \vec{u}₁ and \vec{v}₁ may be made non-positive by flipping the signs of \vec{u}₁ and \vec{v}₁ at the same time. Property 4. When \vec{a}·\vec{t}^{T} is used to approximate X, the square error can be derived from the second through the last singular values as ∥X−\vec{a}·\vec{t}^{T}∥_{F}²=Σ_{i>1}σᵢ². Property 4 can provide a measure on how much information may be captured by the trend 270, e.g., the eigen-trend, and the authority indicator 280, e.g., the authority score.

Compared to traditional count-based trends, the scalar eigen-trend is capable of capturing the main stream of the data set(s) or blog(s) activity more clearly. In the various blog(s) of the blogosphere, entity(ies) or blogger(s) may contribute, post or publish entries that may typically be driven by events (e.g., press releases of new products). If many of the entities or bloggers react to the same events at the same time, their synchronous activity may form a “trend”.

The dominance, popularity or authority score of a data set or blog may serve as a “track record” of the data set or blog over time, to indicate the amount of contribution that the particular data set or blog makes to the main-stream trend. An interested person such as a system user or analyst can focus on such authoritative data set(s) or blog(s) to get deeper insights on the trend. On the other band, if a particular entity(ies) or blogger(s) behaves independently from the main-stream trend, its authority score may be small and its effect on the trend may be discounted. This means that the scalar eigen-trend may be generally less noisy than the count-based trends in extracting the main trend from the observed data. This concept will be demonstrated herein through experiments on various data sets. In addition, the \vec{a}, the first singular vector of X, may be used to represent the general popularity score distribution of the given term or keyword.

The scalar eigen-trend may also capture multiple trends. When the second singular value is large (i.e. the square error of Property 4 is large), another (secondary) trend may be extracted from the data set by using the second singular vector. For example, the same term or keyword (e.g., tax) may be populated by different groups of data set(s) or blog(s) that have different points of view (e.g., finance vs. politics). There may be latent trends on the same term or keyword, which may be combined into the observed data from the data set(s) or blog(s). The traditional count-based method will not be able to decompose such trends. However, the present invention using the second singular value from the scalar eigen-trend may be able to discover these secondary trends from non-dominating interest groups of the data set(s) or blog(s). Examples of such observations and characteristics win be described below when discussing various experimental results.

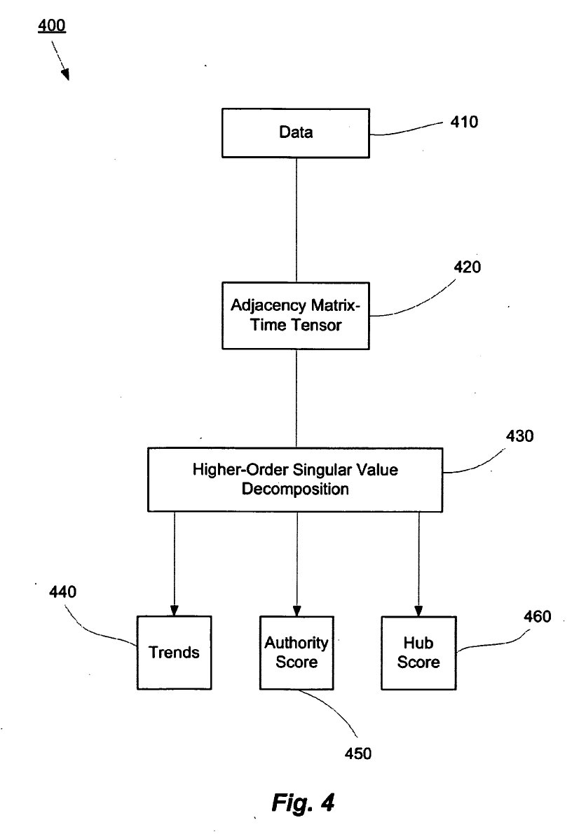

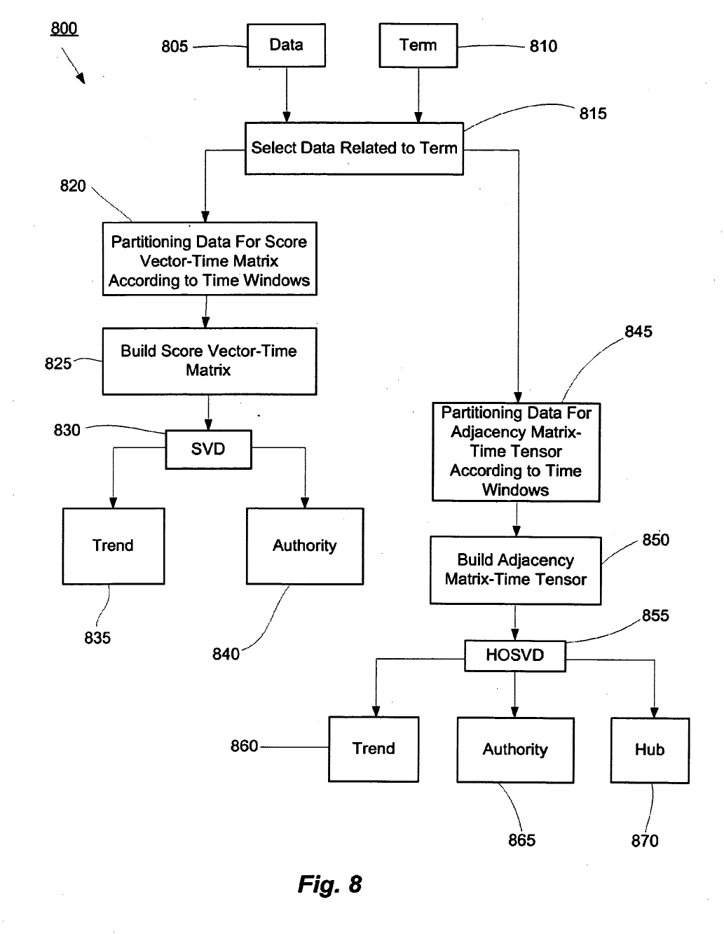

Referring now to FIG. 4, another exemplary data trend extraction and analysis system 400, according to at least one embodiment, is provided. In this example, the trend analysis system 400 may be based on a higher-order singular value decomposition (HOSVD) 430 approach and the results will be referred to herein and coined as a “structural eigen-trend.” The structural eigen-trend may include, for example, a trend indicator 440, and authority indicator or score 450, and a hub indicator or score 460. A data module 410 may include data related to various data set(s) found in one or more data systems. The data in the data module may be resident on one or more computers, computer networks, hand held electronic devices, storage devices, etc. An adjacency matrix-time tensor module 420 may be created from various data set(s) taken from the data module 410. Factors form the adjacency matrix-time tensor module 420 may be converted by a module, for example a higher-order singular value decomposition module 430, that captures and characterizes the structural change over time for a community structure of interrelated data set(s) or blog(s). This module, for example the higher-order singular value decomposition module 430, may operate on a plurality of adjacent matrices over time for a data set(s) or blog(s) to capture and characterize the structural change of a community structure of interrelated data set(s) or blog(s) that occurs over time. The trend 440, authority score 450, and hub score 460, may be extracted by the HOSVD. In at least one embodiment, the singular value decomposition based system and method and the higher order singular value decomposition based system and method may be combined to analyze the same data set(s). This possibility will be described in more detail with reference to FIG. 8 below.

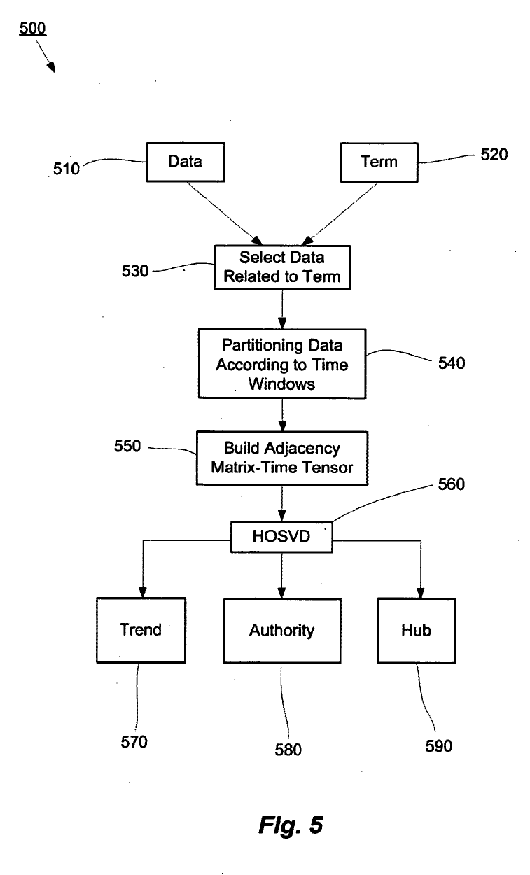

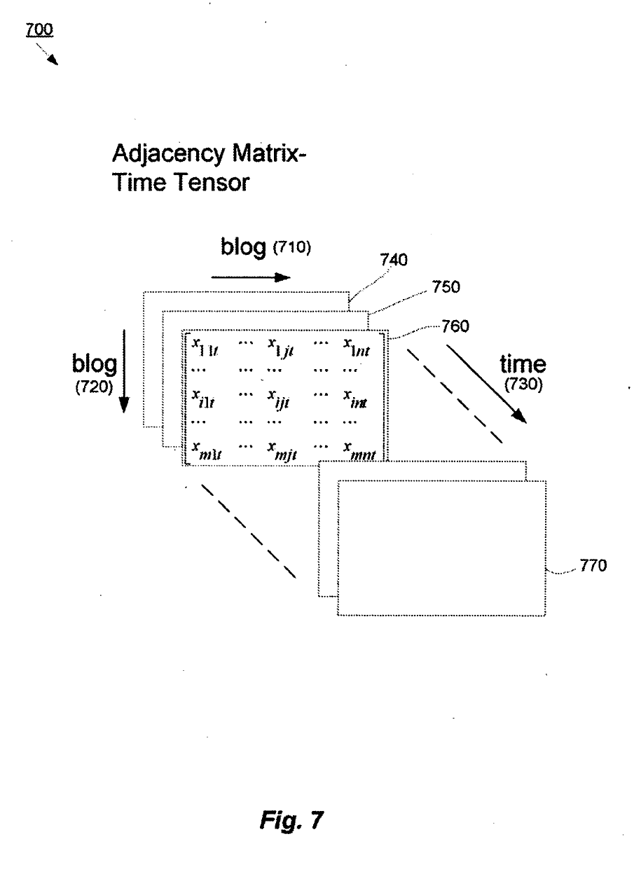

Referring to FIG. 5, another exemplary method for data trend extraction and analysis, according to at least one embodiment, is provided. In this method, similar to the earlier methods, data 510 may be drawn from one or more data set(s) and a term 520 or keyword may be input by a user or entity(ies). Then, at step 530 data related to the term 520 may be selected from the data 510. At step 540 the selected data related to a term from step 530 may be partitioned according to time windows. Next, at step 550, an adjacency matrix-time tensor may be build. An exemplary adjacency matrix-time tensor is shown in FIG. 7 and will be discussed in more detail below. Next, at step 560, a method for identifying various community structural changes over time from the various entries or blogs, for example an HOSVD, may be applied to the partitioned adjacency matrix-time tensors. This method may then provide a trend 570, authority 580, and/or hub 590 as an output. These outputs may be scores. This method will be described in more detail below.

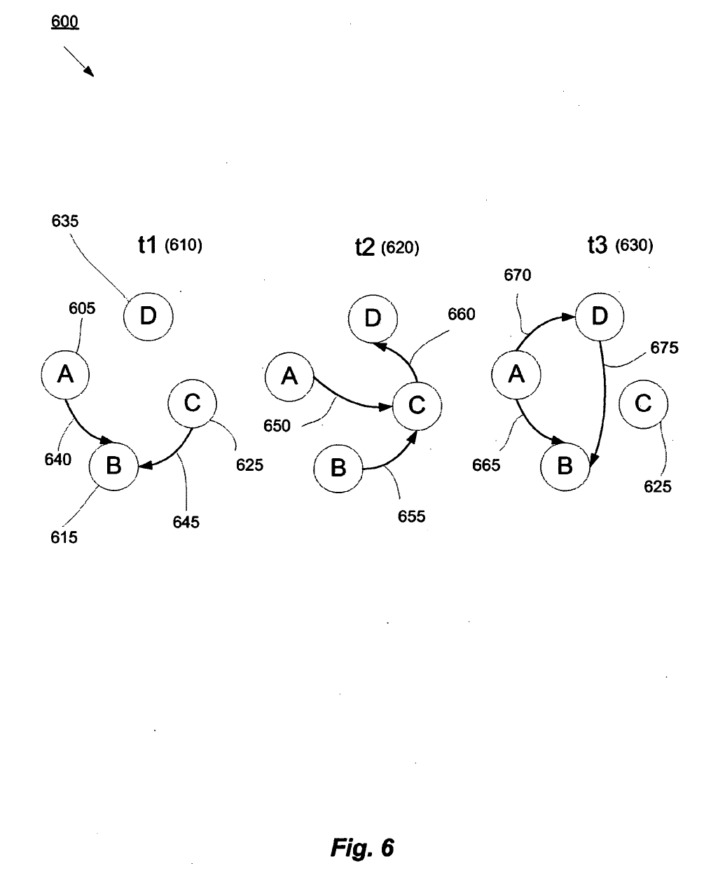

Referring now to FIG. 6, an exemplary node and edge diagram 600 is provided showing data set(s) such as blogs at various nodes and edges interconnect various nodes at various times, thus illustrating changes to a community structure over time. As can be seen, the data set(s) or blog(s) and their interconnections (e.g., cross referencing) may dynamically change. These characteristic and their change may be used for building an adjacency matxix-time tensor for data set(s) or blog(s) at different time intervals, according to various embodiments of the present invention. For example, at time t1 (610) a data set or blog A (605) may refer to data set or blog B (615) thereby creating interconnect or edge 640. Data set or blog B (615) may not refer to any other data set or blog, but may be referred to by data set or blog C (625) so as to establish interconnect or edge 645. Further, there may be a data set or blog D (635) that is not interconnected to any other data set(s) or blog(s) at time interval t1 (610). Then, at time t2 (620) data set or blog A (605) may refer to data set or blog C (625) thereby creating interconnect or edge 650. Data set or blog B (615) may also refer to data set or blog C (625) so as to establish interconnect or edge 655. Further, data set or blog C (625) may refer to data set or blog D (635) so as to establish interconnect or edge 660. At this time interval, t2 (620), all of the observed and analyzed data set(s) or blog(s) are interconnected, but data set or blog D (635) does not refer to any other data set or blog. Finally, at time t3 (630), data set or blog A (605) may refer to data set or blog B (615) thereby creating interconnect or edge 665 and refer to data set or blog D (635) thereby creating interconnect or edge 670. Data set or blog D (635) may refer to data set or blog B (615) so as to establish interconnect or edge 675. Finally, there may be a data set or blog C (625) that does not interconnected to any other data set(s) or blog(s) at time interval t3 (630). These nodes and interconnections, and their changes over time may be equated a plurality of matrices in an adjacency matrix-time tensor.

Referring now to FIG. 7 an exemplary diagram showing an adjacency matxix-time tensor 700 for a plurality of data sets of blogs at different time intervals is provided, according to at least one embodiment of the present invention. The x-axis is a variation of data sets or blogs 710. The y-axis indicates various data sets or blogs 720. The z-axis indicates variation in time or time windows 730. A plurality of data sets or blogs matricies make up the adjacency matrix-time tensor 700 and may include matrix 740 that may represent data sets or blogs A-D for t1 illustrated in FIG. 6, matrix 750 that may represent data sets or blogs A-D for t2 illustrated in FIG. 6, matrix 760 that may represent data sets or blogs A-D for t3 illustrated in FIG. 6, etc., up to matrix 770 that may represent data sets or blogs for a time tn.

Furthermore, for each time window t1, t2, t3, . . . tn, the data set(s) or blog(s) graphs 600 such as shown in FIG. 6 may be represented by its adjacency matrix. The adjacency matrices for the blogs may be stacked in different time windows into an adjacency matrix-time tensor 700, which may be a third-order tenser X. X may represent the dynamic change of the term or keyword-specific blog graph over time t1-tn. A method, for example higher order singular value decomposition, may then be applied on this adjacency matrix-time tensor 700 to determine how the community structure varies over time. Then, the following iterative method (with appropriate normalization) may be used to compute the first left (\vec{h}), right (\vec{a}), and third-mode (\vec{τ}) singular vectors. \vec{τ} may be used to represent an exemplary main trend. In addition, a first left singular vector (\vec{h}) and a first right singular vector (\vec{a}) may be used to represent hub score(s) 590, for example a general hub score, and a general authority score(s) (580) for the data set(s) or blogs over all the time.

In the earlier section related to scalar eigen-trends that may include SVD, an element xᵢⱼ of matrix X may represent a dominance, popularity or authority score of blog i at time j. This dominance, popularity or authority may be measured by the number of relevant entries by blog i at time j. However, such a simple definition may have a weak point: it may ignore various characteristics of the community structure, for example the link information of data set(s) of blog(s) in the blogosphere. For example, if relevant entries by a certain data set or blog always attract a lot of links (e.g., references) from other data set(s) or blogs, then that data set or blog may be considered as more important than some other data set(s) or blog(s). As another example, because the a group of data sets or group of blogs in a blogospbere is an ecosystem in which people or entities are mutually aware of each other and interact with each other, it can be expected that for a given term or keyword, there may exist related communities that exhibit structural consistency over time.

For a given term or keyword a graph Gⱼ for time j, may be constructed and designated the term or keyword-specific blog graph. The nodes of Gⱼ may be the m data sets or blogs. There exists an edge e_{pq} pointing from blog bₚ to blog b_{q} if at time j, there are k (k≧1) links pointing from entries in bₚ to entries in b_{q} that are related to the term or keyword. The weight of e_{pq} may be set to be k. An entry-to-entry link e_{pq} may be defined to be related to a term or keyword if either the citing entry in bₚ or the cited entry in b_{q} contains the term or keyword. The term or keyword-specific data set or blog graph may be observed through n consecutive time windows. If each graph is represented as an m×m adjacency matrix, the entire data is represented as a third-order tensor Xε [symbol] ^{m×m×n}, where the first two dimensions of X may be respectively the rows and columns of the adjacency matrices, and the third dimension is the time line.

As mentioned above, various embodiments of the present invention, the method(s) and system(s) may be used to directly analyzes trends in dynamically changing graph structures or communities of interrelated data sets, e.g., blogs, which has been identified herein as a structural eigen-trend. Higher-order singular value decomposition (HOSVD) may be applied to the observed data X. X may be represented by, for example, three vectors: a trend vector \vec{t} (e.g., a structural eigen-trend), an authority vector \vec{a}, and a hub vector \vec{h}. Whereas the scalar eigen-trends previously introduded may represent the characteristics of individual entities or bloggers with one or more vectors, e.g., a single vector such as an authority vector, this trend analysis technique may provide a pair of vectors \vec{a} and \vec{h}. Further, extending this concept, the present invention may capture a community that consists of hub and authority blogs and may track the structure of the community over time. The following description gives a more detailed description of one of the methods that may be use for the structural eigen-trend technique.

Generally, a singular value decomposition may be applied to X for trend analysis on a dynamically changing graph structure. However, unlike the case of a matrix, singular value decomposition may not be uniquely defined on higher-order tensors. Among the various techniques developed, one exemplary technique that may be used can adopt a framework like one proposed by De Lathauwer et al., which is described as follows. First the singular value decomposition X=UΣV^{T} may be rewritten by using n-mode product as:
X=Σx₁Ux ₂V (5)
where in general, for a tensor Aε [symbol] ^{I}^{₁}^{x . . . xI}^{ₙ}^{x . . . xI}^{_{N}}, the n-mode product operator xₙ of A by a matrix Mε [symbol] ^{J}^{ₙ} ^{×I}^{ₘ} will result in a tensor B=AxₙMε [symbol] ^{I}^{₁}^{x . . . xI}^{_{n−1}}^{xJ}^{ₙ}^{xI}^{ₙ₊₁}^{x . . . xI}^{_{N}} where

$${( B )}_{{i}_{1} … {i}_{n - 1} {j}_{n} {i}_{n + 1} … {i}_{N}} = {\sum }_{{i}_{n} = 1}^{{I}_{n}} {( M )}_{{j}_{n} {i}_{n}} {( A )}_{{i}_{1} … {i}_{n - 1} {i}_{n} {i}_{n + 1} … {i}_{N}}$$

In other words, an n-mode product xₙ of A may apply a linear transformation (represented by M) to all the n-mode vectors of A, where an n-mode vector of A is an Iₙ-dimensional vector obtained by varying the nth index of A from 1 to Iₙ while keeping all other indices fixed. Because a matrix is a special case of tensor, the natural question is if we can generalize Equation (5) to singular value decomposition on higher-order tensors. De Lathauwer et al. proposed a way of doing that and called the method a higher-order singular value decomposition (HOSVD). De Lathauwer et al. showed that for a tensor Xε [symbol] ^{I}^{₁}^{x . . . xI}^{ₙ}^{x . . . xI}^{_{N}}, we can decompose X as
X=Sx₁U⁽¹⁾x₂U⁽²⁾ . . . x_{N}U^{(N)} (6)
where U⁽ⁿ⁾ε [symbol] ^{I}^{ₙ}^{xI}^{ₙ}are orthogonal matrices. In Equation (6), Sε [symbol] ^{I}^{₁}^{x . . . xI}^{_{N}} may be called the core tenisor. In general, S is not diagonal (in the sense that non-zero elements only occur at positions where i₁=. . . =i_{N}) and the decomposition given by Equation (6) does not have the property of best low-rank approximation. However, De Lathauwer et al. further proposed an iterative power method that guarantees the best rank-1 approximation.

Based on this power method, the present invention may us a similar method including the following steps to compute the trend in data set(s) or blog(s) in the blogosphere. First, a third-order tensor X as described above may be built to represent the dynamic change of the term or keyword-specific data set(s) or blog graph(s) over time. Then an iterative method (with appropriate normalization) may be used to compute the first left (\vec{h}), the first right (\vec{a}), and third-mode (\vec{τ}) singular vectors.

$$\{ \begin{matrix}{\vec{h}}_{k + 1} = X {\times }_{2} {\vec{a}}_{k} {\times }_{3} {\vec{τ}}_{k} \\ {\vec{a}}_{k + 1} = X {\times }_{1} {\vec{h}}_{k + 1} {\times }_{3} {\vec{τ}}_{k} \\ {τ}_{k + 1} = X {\times }_{1} {\vec{h}}_{k + 1} {\times }_{2} {\vec{a}}_{k + 1} \\ {λ}_{k + 1} = ‖ {\vec{τ}}_{k + 1} ‖\end{matrix} \qquad ( 7 )$$

It may be shown that the above iteration converges to solutions \vec{h}, \vec{a}, \vec{τ}, λ, such that \vec{h}·\vec{a}·λ\vec{τ}, with · being the tensor outer product, is the rank-1 tensor that best approximates X in terms of Frobenius norm (square error). In various embodiment of the present invention, \vec{i}=λ\vec{τ} may be used to represent the temporal trend for the term or keyword-specific data set or blog graph(s).

Thus, as noted above, the trend \vec{t} may be called herein a structural eigen-trend to distinguish it from the scalar eigen-trend. The first left and right singular vectors, \vec{h} and \vec{a}, may be called hub scores and authority scores, respectively, based on the following intuitive interpretations.

In the HITS algorithm mentioned above, for an adjacency matrix X, the hub score, which is the first left singular vector of X, may represent the goodness of the Web pages on summarizing a keyword; the authority score, which is the first right singular vector of X, represents the goodness of the Web pages on being authorities of the keyword. In at least one embodiment of the present invention, because \vec{h} and \vec{a} may be extracted from the tensor X, they can be considered as the general hub and authority scores that may capture the main community structure related to a term or keyword in the dynamically changing term or keyword-specific data set or blog graph. From Equation (7) it can be observed that after \vec{h} and \vec{a} have converged, the trend at time j is the projection of the keyword-specific blog graph Gⱼ onto the main community represented by the outer product of \vec{h} and \vec{a}. Also from Equation (7) the following can be observed: Property 5. The HITS algorithm is a special case of our method by taking a single lime window i.e., taking n to be 1.

Of course, the eigen-trend approach of the present invention is good for analyzing other graph structures. The term or keyword-specific blog graph is illustrated here only as an example; the trend analysis technique presented can be applied to other general graph structures for many other types of data sets, for example, listed open postings to web sites such as Wikipedia, open postings to Craigslist, etc., as well as to analyze various other dynamically changing undirected graph structures. In the cases of undirected graphs, instead of the pair of hub and authority scores, a single eigen vector that represents the main “shape” of the graph structures may be utilized and/or provided.

In addition, the following property for the trend analysis based on HOSVD can be easily verified. Property 6. If all elements of a third-order tensor X are non-negative, the iteration given in Equation (7) will converge to a solution such that \vec{h}, \vec{a}, \vec{τ} and λare all non-negative.

There are a number of benefits to using the structural eigen-trend techniques of the present invention. Some exemplary ones follow. Compared to the scalar eigen-trends, the structural eigen-trends focus on and exploit the link structure in the data set(s) or blog(s) of a blogosphere. Whereas the scalar eigen-trends may emphasize the main group of data set(s) or blogs that publish entries individually, the structural eigen-trends may depict activity of the main community that consists of, for example, hubs and authorities referencing each other. Rather than just applying the HITS algorithm to individual time windows, various embodiments of the present invention may track the linking behavior of the data set(s) or blogs to find constant hubs and authorities over. time. It can discount effects from a particular data set or blog that does not follow the main trend on linking behavior (for example, a data set or blog that generates links randomly) even if it looks like a hub within a specific time window. Similar to the scalar eigen-trend, the secondary trend can be useful, for example, to detect another community behaving differently from the main community.

Referring now to FIG. 8, another exemplary method for data trend extraction and analysis 800 is provided, according to at least one embodiment. In this example, the SVD and HOSVD approaches are combined to provide an even more robust trend analysis system and method. In this embodiment, at 805 data from a data set(s) and at 810 a term(s) (e.g., a keyword) selection made by, for example, a user(s)/entity(ies) may be provided. The data may come from the Internet, and intranet, an ad-hoc peer-to-peer network, one or more portable electronic devices, etc. Then at step 815, data from the data set(s) may be selected as data related to the term(s) or keyword(s). Next, at step 820, the selected data related to a term may be partitioned according to time windows. Further, at step 825, a score vector-time matrix may be build from the partitioned data according to time windows produced in step 820. Then at step 830, a singular value decomposition (SVD) may be used to process the time windows to produce at step 835 a representation of an overall trend factor and at step 840 an authority factor that represents the contribution of one or more individual user(s)/entity(ies). For example, the trend factor may be a trend vector representing the overall trend(s) over time and the authority factor may be a vector that representing the contribution of the individual user(s)lentity(ies), with respect to for example bolg(s). In addition, after step 815 at step 845, data may be partitioned for adjacency matix-time tensor according to time windows. In any case, then at step 850 an adjacency matrix-time tensor may be built from the partitioned data developed at step 845. Next, at step 855, a method for identifying various community structural changes over time from the various entries or blogs, for example an HOSVD, may be applied to the partitioned adjacency matrix-time tensors. This method may then provide a trend 860, authority 865, and/or hub 870 as an output. These outputs may be scores.

As previously noted, in one of the exemplary applications of the present invention trend analysis of blogs if performed. The blogosphere is an ecosystem in which blogs interact with each other generating reference structure. In this sense, the blogosphere may be considered as a blog graph where the nodes are blogs and the links reflect endorsements and interactions among blogs. In addition, such a blog graph is changing with time as a result of the development of internal relationships (e.g., interactions among blogs) and external events (e.g., breaking news). Various embodiments of the present invention are directed to analyzing and extracting meaningful trends from such a dynamically changing graph structure.

The present invention's capability and usefulness have been demonstrated using trend analysis and extraction using experiments. Experiments were conducted on synthetic data sets to verify the benefits of eigen-trends, according to at least one embodiment of the present invention. Further, experiments of case studies on a real blog data set were conducted to show interesting trends that are revealed by the systems and methods of the present invention, which are not available through traditional count-based methods.

The synthetic data sets were generated as follows. To study the SVD-based trend extraction method, entries are generated from 10 blogs over 250 time units. In a time unit, each blog generates a random number of entries where the number follows a uniform distribution. The mean values of the distribution are different for different blogs. For easy viewing, we let the mean values vary with time following a sinusoid trend.

To study the HOSVD-based trend extraction method, links are generated among 10 blogs over 250 time units. The number of links in each time unit follows a uniform random distribution whose mean value varies over time following a sinusoid trend. When a link is generated, unless stated otherwise, a source blog and a target blog are selected at random, following distributions pre-defined by two unit vectors. These two vectors serve as the underlining hub and authority scores. It should be noted that compared with the real blogosphere, the scale of the examples presented herein is small but the results found are indicative.

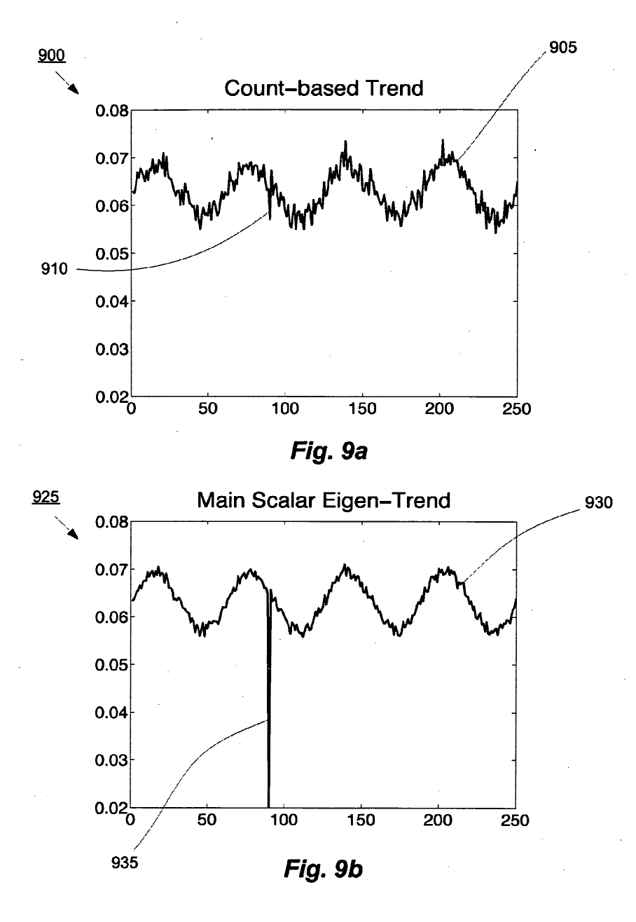

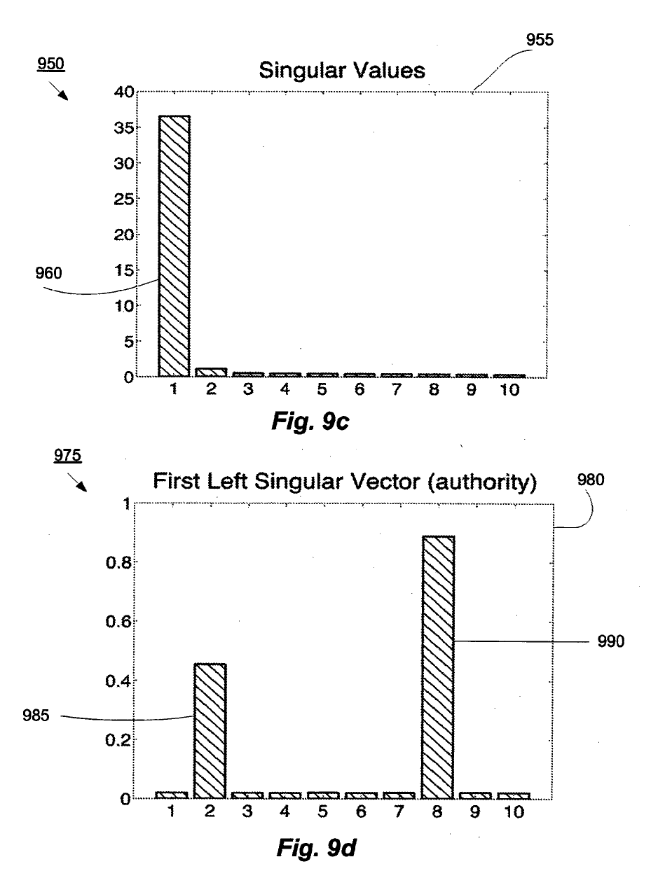

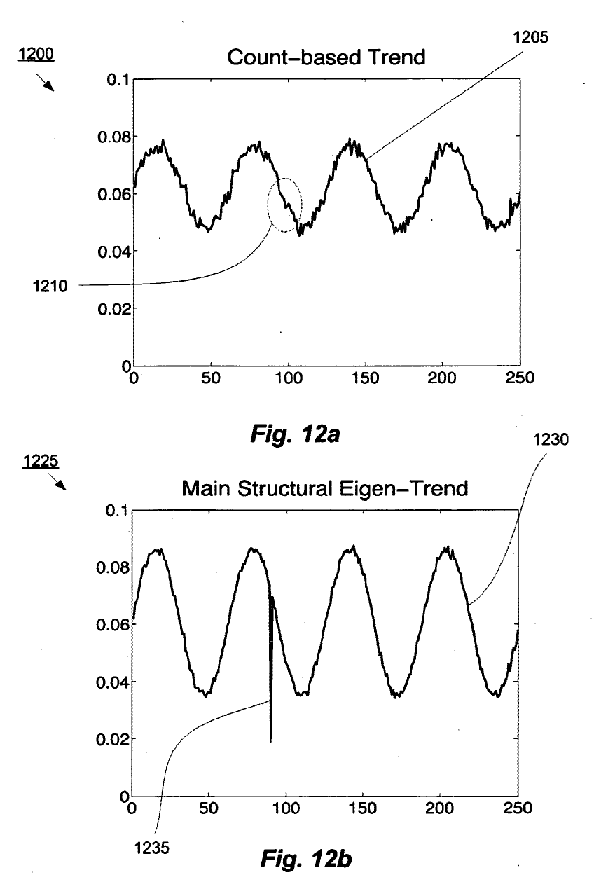

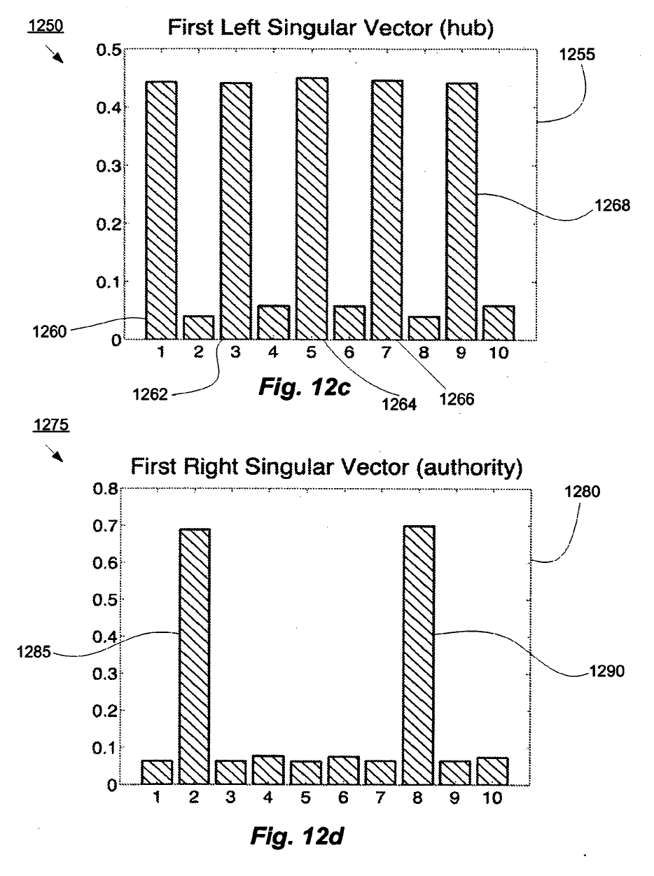

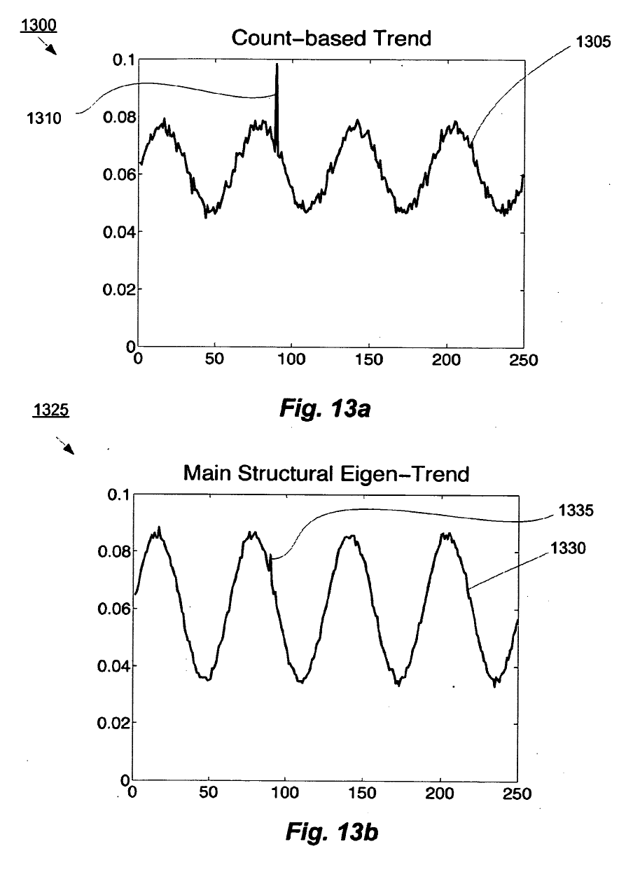

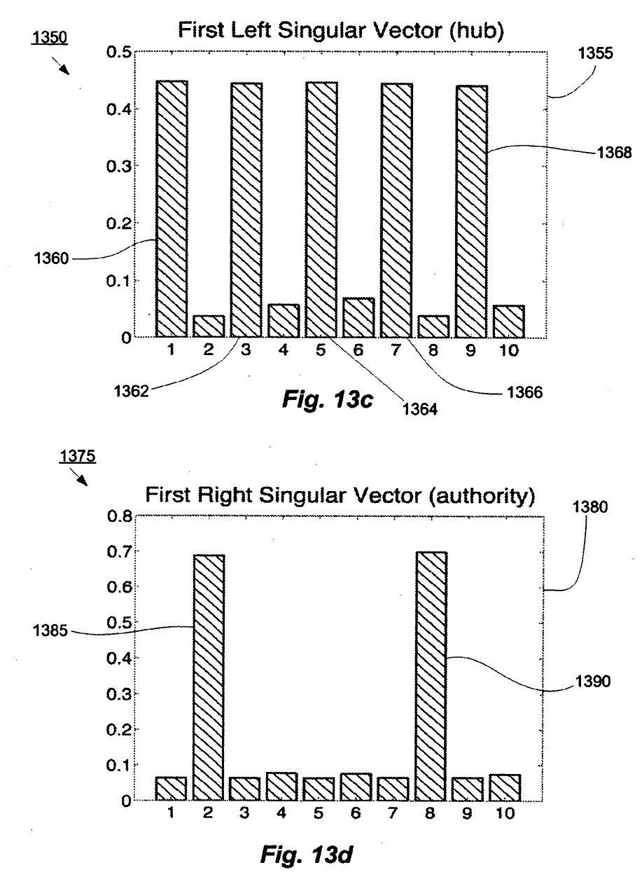

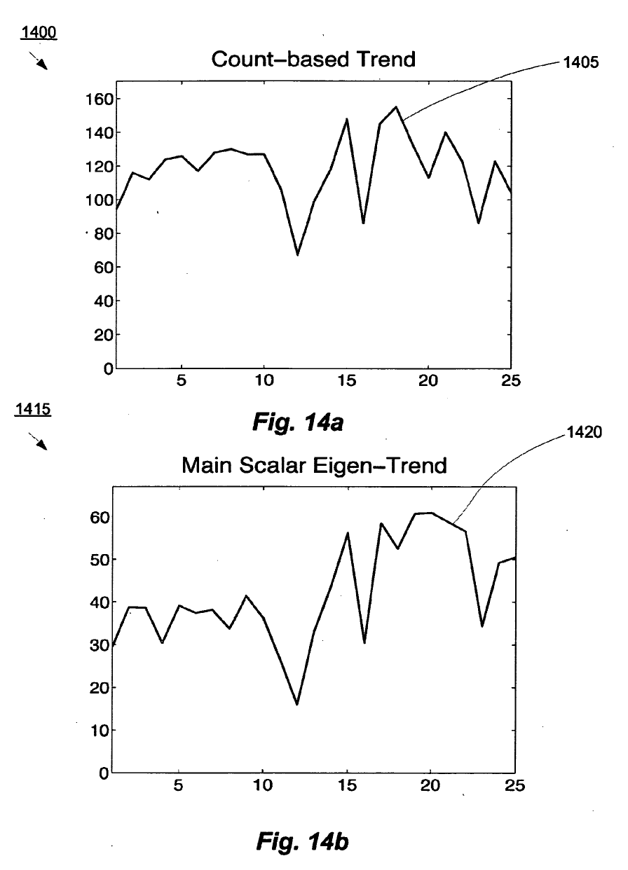

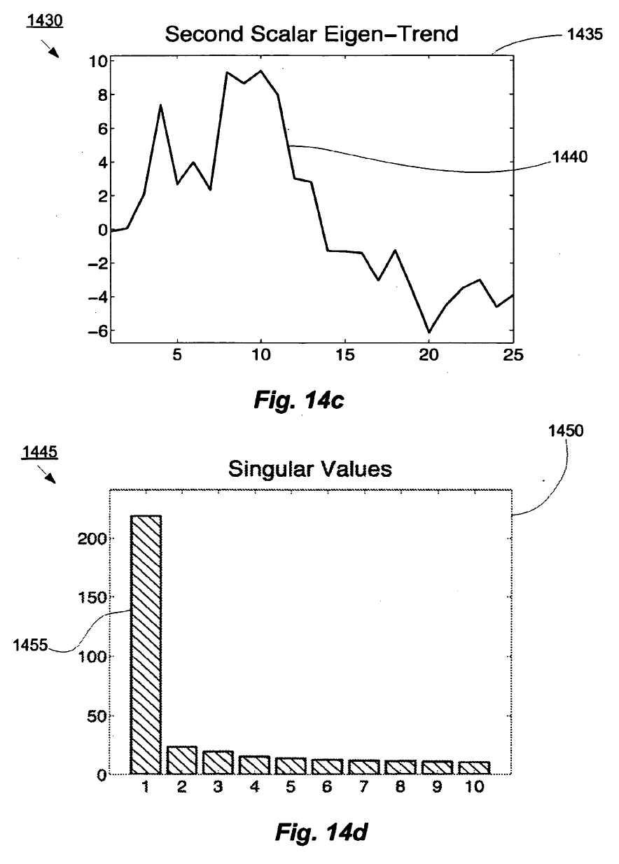

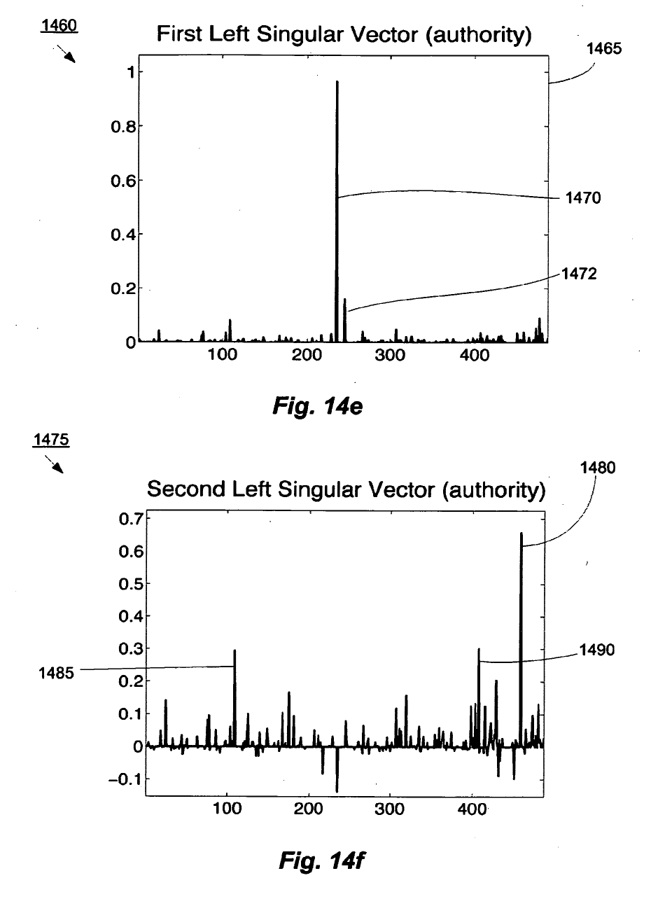

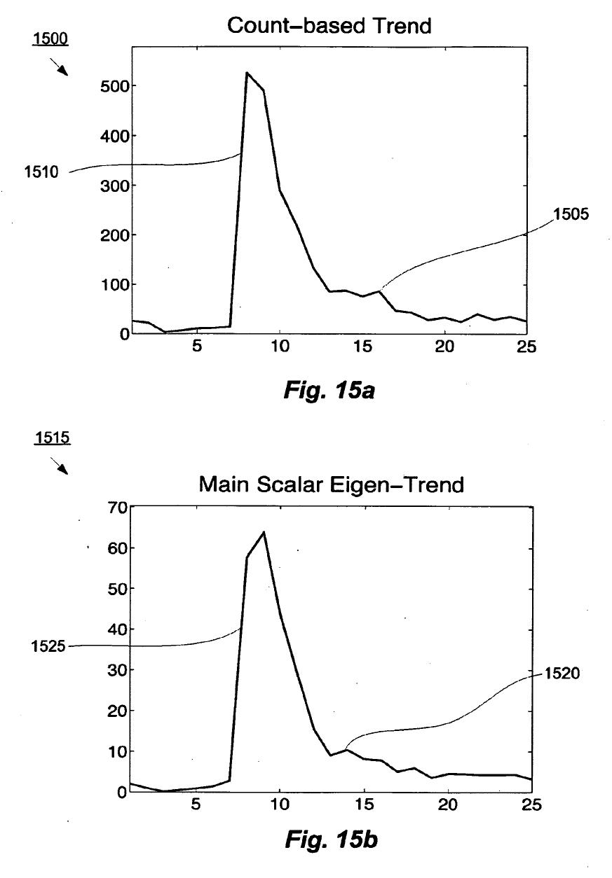

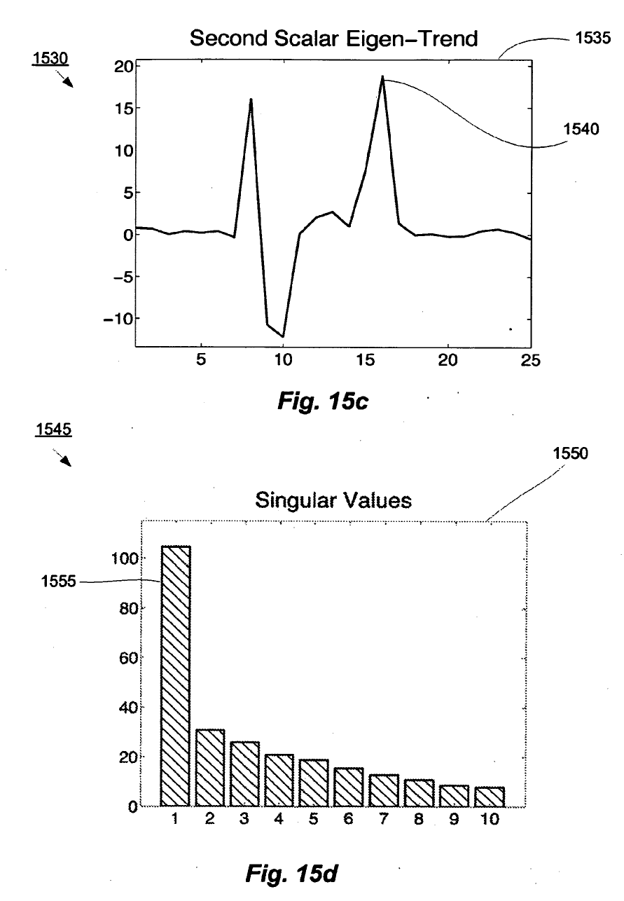

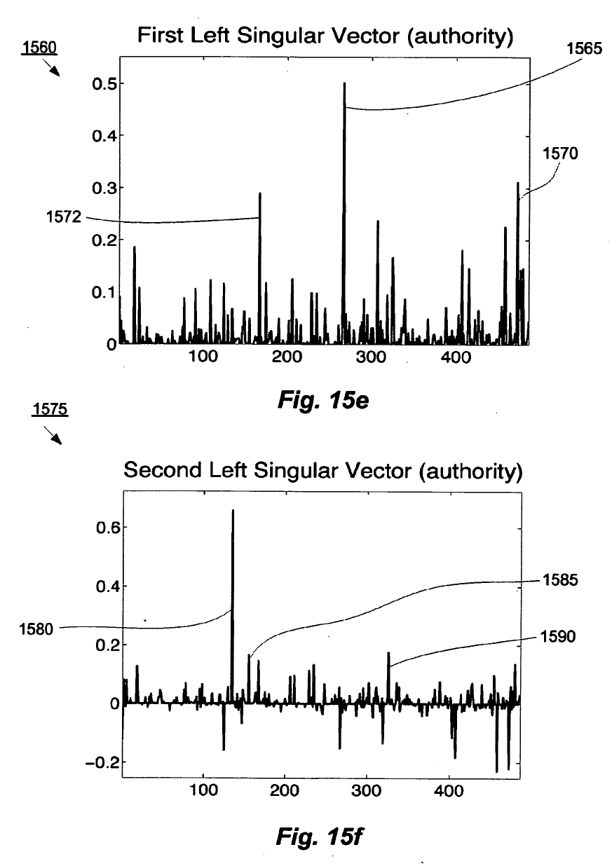

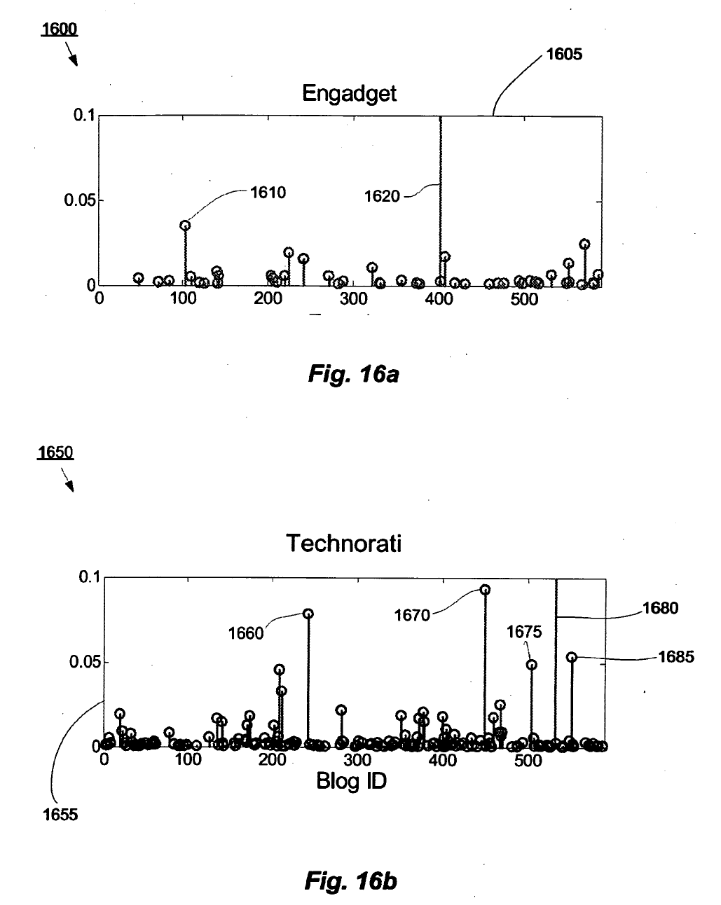

The experimental results tha follow shown in FIGS. 9a-11f are directed to scalar eigen trends and the experimental results shown in FIGS. 12a-13d are directed to structural eigen-trend analysis for synthetic data. The experimental results shown in FIGS. 14a-15f are directed to scalar eigen trends and the experimental results shown in FIGS. 16a-18 are directed to structural eigen-trend analysis for real data.

Referring to FIGS. 9a-9d, in this example, the data set is generated in such a way that two blogs (blogs 2 and 8) dominate the entries. That is, when generating entries, the mean values for the random distributions of blogs 2 (bar 985 in FIG. 9d) and 8 (bar 990 in FIG. 9d) are higher than those of other blogs. This data set simulates the case in which, for example, a few blogs dominate the discussion on a topic in the blogosphere (e.g., blogs that are completely devoted to reviewing the features of iPod). Then, at a particular time period, in this case time 90, one of the dominating blogs, blog 8, generates much fewer entries than usual. The results are shown in FIGS. 9a-9d.

It should be noted that, for all the figures shown herein for trend (e.g., count-based trend, scalar eigen-trend, and structural eigen-trend) have an x-axis representing the time windows and the y-axis represents the trend values. For other singular vectors, the x-axis denotes the blog number from 1 to m where m is the total number of blogs. For the singular values, if we show the top k singular values, then the x-axis denotes the index for the singular values from 1 to k.

As can be seen from FIGS. 9a and 9b, in this example, both the count-based method in graph 900 and the SVD-based method in graph 925 capture the main sinusoid temporal trend, 905 and 930, respectively. However, the scalar eigen-trend in graph 925 captures the under-representation of the dominating blog at time 90 (935), whereas in the count-based trend, the drop 910 is much less pronounced. In addition, with reference to FIGS. 9c and 9d, the SVD-based method results of the present invention is much better than the traditional trend at showing which blogs dominate over all the time windows. As shown FIG. 9d, the SVD may automatically compute the authorities of all the blogs (the first left singular vector shown in FIG. 9d shows that blog 2 bar 985 is higher and that blog 8 bar 990 is high) and the measure on the approximation error for the main scalar eigen-trend (the top 10 singular values shown in FIG. 9c shows that at the first singular vector, bar (1) 960, is much greater than any of the bars representing the other singular vectors (bars 2 through 10)).

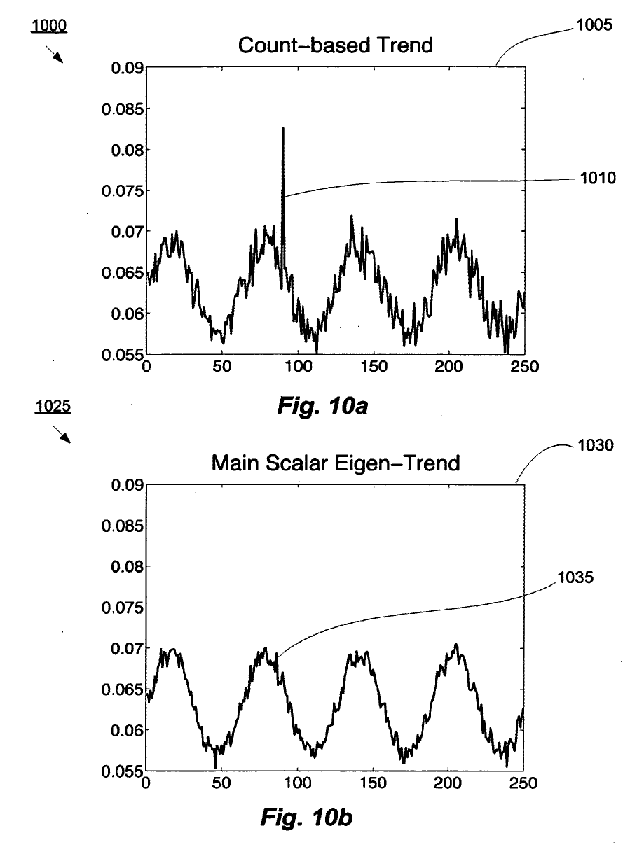

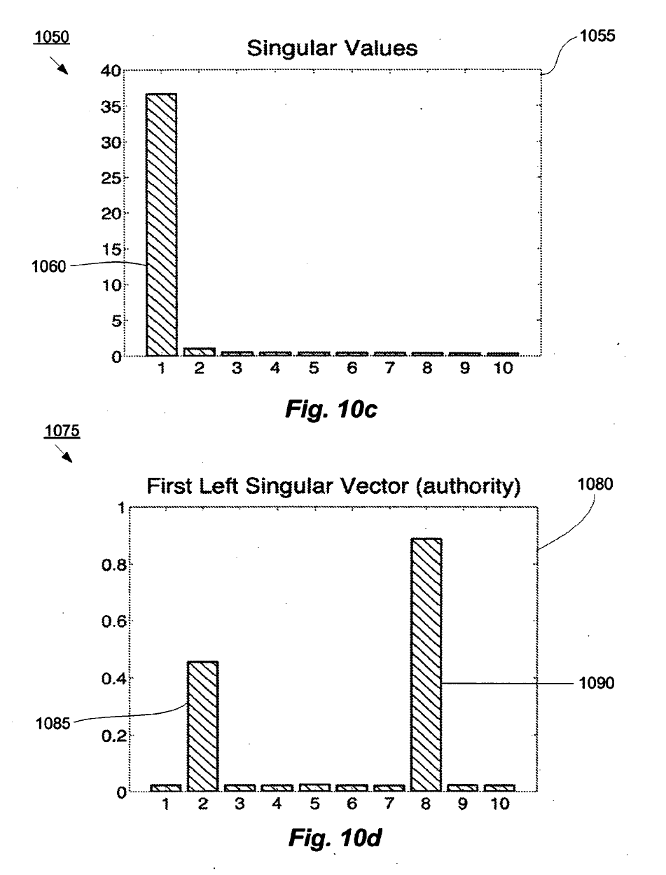

Referring to FIGS. 10a-10d, an example that is contrary or opposite the above example is provided as illustrated by the various graphs. In this example, the data set is generated in a similar way such that, at time 90, one non-dominating blog, blog 5, posts an abnormally large number of entries. This abnormality is largely ignored by the scalar eigen-trend in 1035 shown in graph 1025. In comparison, the count-based trend 1010 is impacted greatly as shown in graph 1000. This example illustrates that in scalar eigen-trends, for a blog to have high impact on a term or keyword, a track record is needed to be built over time, and a one-time shot does not count very much.

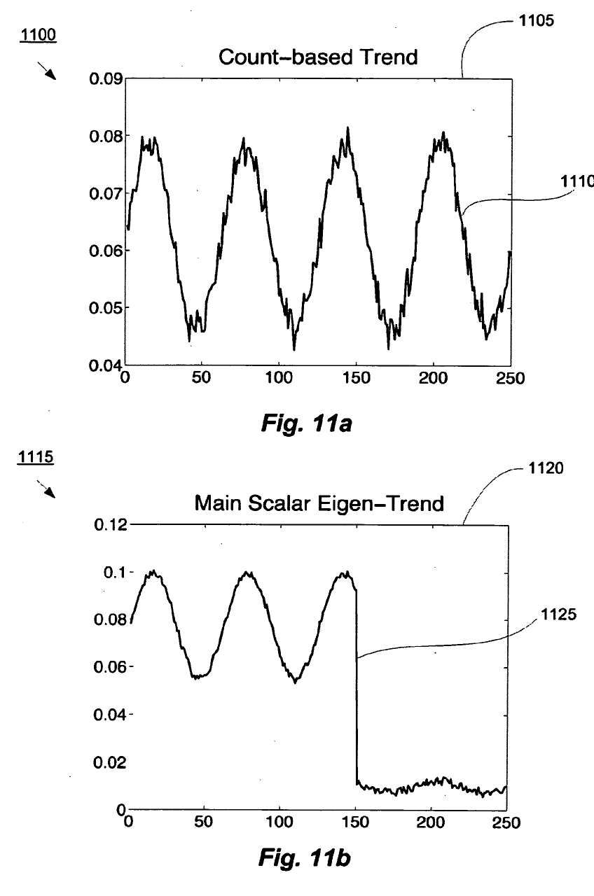

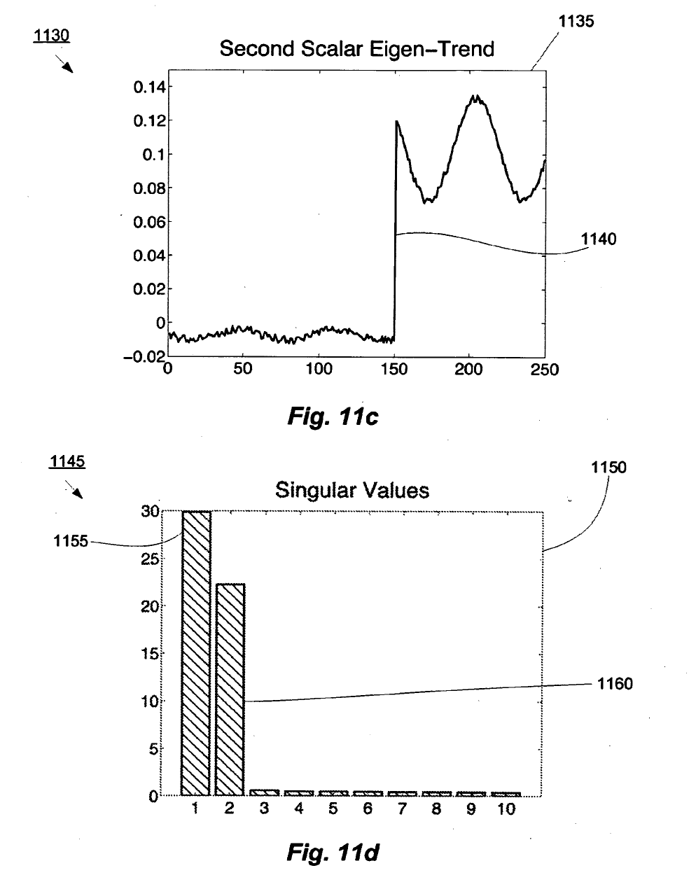

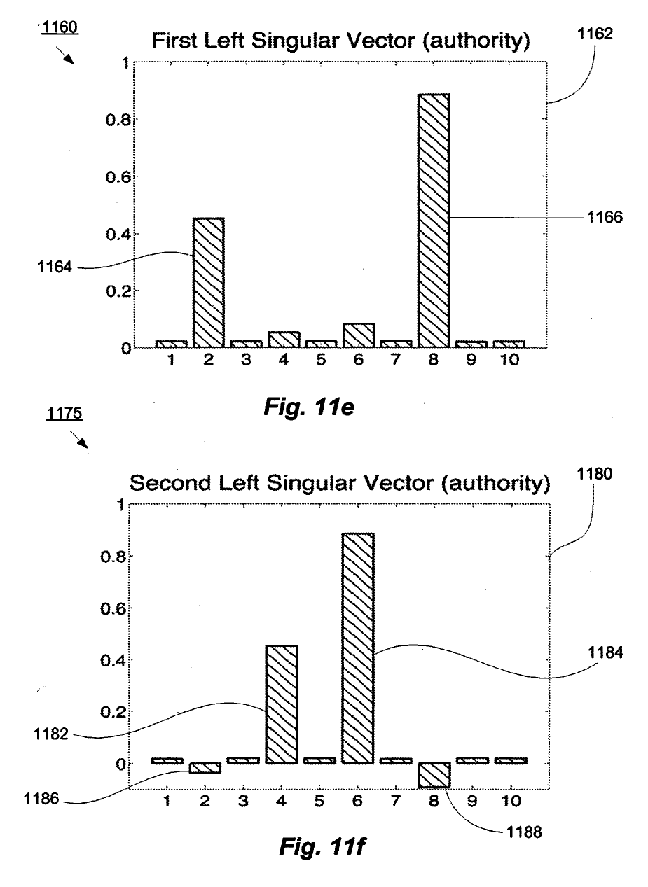

Referring to FIGS. 11a-11f, the various graphs are used to show multiple trends within data set(s). When generating the data set, during the first 150 time units, blogs 2 (1164 in FIG. 11e) and 8 (1166 in FIG. 11e) dominate the entries and then during the last 100 time units, the dominating blogs are switched to blogs 4 (1182 in FIG. 11f) and blog 6 (1184 in FIG. 11g). This example is used to simulate the case in which two distinct groups of blogs discuss different aspects of the same term(s) or keyword(s) following different temporal patterns. The first and second scalar eigen-trends 1125 in FIG. 11b and 1140 in FIG. 11c, accurately capture trends in the two interest groups. In addition, the corresponding authority scores (left singular vectors) shown in FIG. 11e and FIG. 11f reflect the membership of the blogs in each interest group. Furthermore, the magnitude of the singular values 1155 and 1160 shown in FIG. 11d provides hint on how dominating each group of blogs are in the blogosphere.

Referring to FIG. 12a- 13d, experimental results for structural eigen-trends are provided for at least one embodiment of the present invention. Referring to FIGS. 12a-12d, various graphs are shown which illustrates that when a link is generated, the probability for a blog to be chosen as the source blog is uniformly distributed among blogs 1 (1260 in FIG. 12c), 3 (1262 in FIG. 12c), 5 (1264 in FIG. 12c), 7 (1266 in FIG. 12c), and 9 (1268 in FIG. 12c), the probability for a blog to be chosen as the target blog is uniformly distributed over blogs 2 (1285 in FIG. 12d) and 8 (1290 in FIG. 12d). In addition, random links are added as noise. However, at time 90 (sharp decline 1235), the graph structure 1230 changes. At time 90, instead of using the hub and authority scores, all links are generated totally randomly by equally likely selecting any blog to be the source or the target. The structural change is detected by the structural eigen-trend in FIG. 12b, sharp decline or valley 1235, but is not detectable by the count-based trend in FIG. 12a at location 1210. The drop in the structural eigen-trend suggests that at time 90 the number of links that follow the normal graph structure (which is represented as the authority and hub scores) is much lower than usual, which suggests a structural change at time 90.

Referring to FIGS. 13a-13d, this example is somewhat contrary or the opposite of the example shown in FIGS. 12a-12d, although, links are generated in a similar way. As shown by the graph 1300, at time 90 (spike 1310), blog 6, which is not a good hub, generates a lot of links pointing to the two authorities 2, blog 2 (bar 1385 in FIG. 13d) and blog 8 (bar 1390 in FIG. 13d). While this spam-like behavior impacts the count-based trend in 1305 greatly at spike 1310, the structural eigen-trend in trace 1380 largely ignores these usual links as indicated by the relatively change 1335 in the trend. Thus, using the present invention, to become a valid hub, a blog must build a track record of consistently pointing to good authorities over all the time.

Referring now to FIGS. 14a-18, experimental results for various real blog data sets will be discussed. For most of the real data experimental results, a blog data set obtained by an in-house crawler developed at NEC Laboratories American is used. For this analysis, a subset of English blogs consisting of 114,645 entries that belong to 486 blogs crawled between Jul. 10 and Dec. 30, 2005, for a period of 25 consecutive weeks was extracted. In addition, there are a total of 34,994 links in the data set. Although the data set is relatively small compared to those from large-scale commercial blog search engines, it is apparent that the technique of the present invention is able to discover trends that are not available through traditional methods. Some experimental results are shown using Engadget and Technorati as the term or keyword.

Referring to FIGS. 14a-14f, various graphs show the experimental results of scalar eigen-trend analysis for the URL's of top authority blogs for the term or keyword “tax.” It can be observed that the first and the second scalar eigen-trends in FIG. 14b (trend 1420) and FIG. 14c (trend 1440) follow different patterns. The main scalar eigen-trend 1420 is predominantly driven by a group of blogs with financial interests. For example, the blog in this group with the top authority belongs to a law professor who is a leading tax scholar and is indicated in FIG. 14e by the spike 1470 (http://taxprof.typepad.com/taxprof.blogt) and the second most authoritative is Tim Worstall indicated by spike 1472 (http://timworstall.typepad.com/timworstall/). Main topics covered by this group of blogs include IRS rules, tax guide for organizations and individuals, etc. As can be expected, the number of entries from these blogs increases dramatically toward the end of fiscal year, when tax becomes a more important issue. Because most entries from these blogs contain the keyword “tax,” these blogs dominate the blogosphere and the count-based trend 1405 in FIG. 14a follows this main scalar eigen-trend. On the other hand, the authorities in the second interest group are mainly political blogs as indicated in FIG. 14f by the spike 1480 (http://www.theleftcoaster.com/) spike 1485 (http://www.preemptivekarma.com/) and spike 1490 (http://www.ezraklein.typepad.com/blog/). Tax-related topics in these blogs include taxation, tax rates, tax cuts and their political consequences. The second scalar eigen-trend in FIG. 14c (trend 1440) reveals another trend that belongs to a group behaving differently from the first group.

Referring to FIGS. 15a-15f, various graphs are provide that show the experimental results of trends for the tern(s) or keyword(s) “hurricane.” Hurricane Katrina took place during week 7 in the time frame shown in FIGS. 15a-15c. As can be seen from the count-based trend in FIG. 15a, the peak 1510 indicates that many entries were posted immediately after Hurricane Katrina and interest in this topic waned 1505 after a few weeks. It can also be appreciated that the main scalar eigen-trend in FIG. 15b had a peak 1525 and drop off 1520, obtained by the SVD-based method of the present invention, that follows the count-based trend 1500 closely and is driven mainly by blogs reporting news related to Hurricane Katrina and discussing the economic and political impacts of the hurricane. The most dominant, popular, or authoritative blogs are shown as peaks in FIG. 15e illustrating the First Left Singular Vector (authority) include spike 1565 (http://wizbangblog.com/),spike 1570 (http://www.washingtonmonthly.com/), and spike 1572 (http://michellemalkin.com/). In comparison, the second interest group mainly consists of less well-known personal blogs and are shown in FIG. 15f illustrating the Second Left Singular Vector (authority) including spike 1580 (http://hyku.com/blog/), spike 1585 (http://www.donaldsensing.com/) and spike 1590 (http://majikthise.typepad.com/majikthise/). Their main topics related to Hurricane Katrina include personal experiences, helping the victims, making donations, etc. In the second scalar eigen-trend shown in FIG. 15c, the impact that corresponds to this second group of blogs is another spike 1840 that occurs in the 16th week. The reason for this spike is that due to the nature of this group, they discussed in a similar fashion a subsequent hurricane, Hurricane Wilma. Because Hurricane Wilma has less dramatic political or economic impact than Hurricane Katrina, as we can see from graph at 1505, its impact is negligible in the count-based trend 1500.

Referring to FIGS. 16a and 16b, a graph 1600 depicts the popularity or authority distribution for the term or keyword “Engadget” 1605 and a graph 1650 depicts the popularity distribution for the term or keyword “Technorati” 1655. As revealed by the graph for Engadget 1600, only a couple of blogs (for example, 1620 and 1610) have large values in the popularity distribution. In contrast, the graph for Technorati 1650 reveals that many blogs (for example, 1660, 1670, 1675, 1680 and 1685) have considerably large values in the popularity or authority distribution. This data suggests that Engadget is popular in a relatively small community of bloggers while Technorati is more popular in the general public. Engadget is the name of a blog site listing the latest news on high-technology gadgets while Technorati is the name of a general blog search engine. This explains why the latter is more popular in the general public than the former.

As noted above, FIGS. 16a and 16b shows the popularity or authority distributions, i.e., the \vec{a} vectors, for the two keywords. As revealed by the figure, for Engadget, only a couple of blogs have large values in \vec{a} while for Technorati, many blogs have considerably large values in \vec{a}. Because the popularity distribution \vec{a} has unit 2-norm, we are able to directly compare the \vec{a} vectors for different keywords. For this purpose, we first normalize \vec{a} into unit 1-norm vector by defining \vec{a}′={a₁′, . . . , aₘ′} as \vec{a}′=\vec{a}/∥\vec{a}∥₁. Next, we define a vector

$${\overline{α}}^{o} = \{ {a}_{1}^{o} , ⋯ , {a}_{m}^{o} \} = \{ \frac{1}{m} , ⋯ , \frac{1}{m} \}$$

to represent the popularity distribution of a fictitious keyword that is popular equally among all bloggers. We then may use, for example, the Kullback-Leibler divergence between the \vec{a}′ vector of a keyword and \vec{a}^{o}, i.e.,

$${\sum }_{i = 1}^{m} {a}_{i}^{′} \cdot log ( {a}_{i}^{′} / {a}_{i}^{o} )$$

, to measure how general a keyword is. Intuitively, the lower the divergence for a keyword, the “flatter” the distribution and hence the keyword is popular in the more general public. In our example, the divergence for Engadget is 7.21 and that for Technorati is 3.68. Applying this measure, we are able to order some representative keywords from more “spiky” distributions to “flatter” distributions as PowerPC, Engadget, MSDN, iMac, TiVo, Macromedia, RFID, Palm, Netflix, Slashdot, Windows Vista, Xbox, Windows XP, iPod Shuffle, Flickr, MSN, iPod Nano, Technorati, iPod, Google, Yahoo, Network, Internet). This result matches our common sense quite well, because the keywords in the front of the list seem to be the names of products with narrower audience while those at the end of the list seem to be more general brand or technology names in which more people are interested.

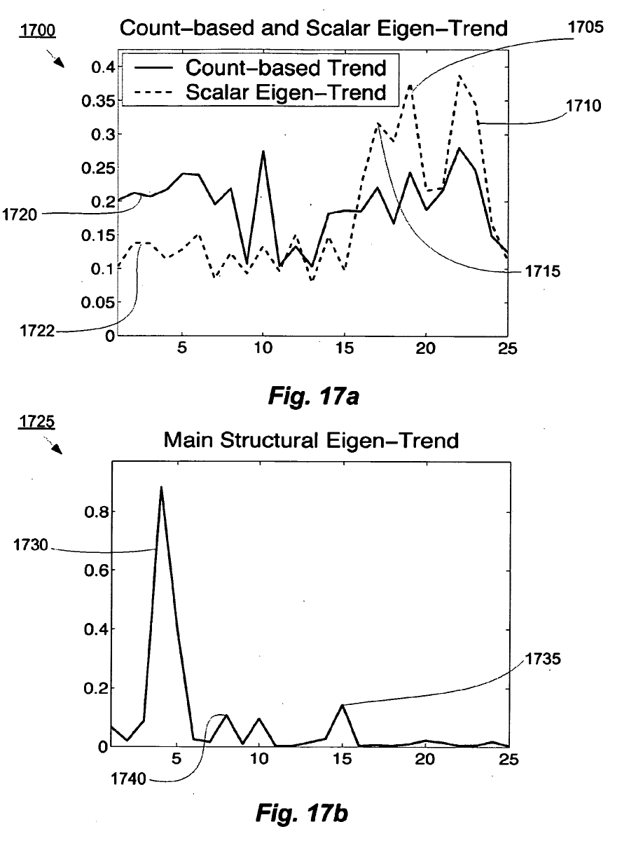

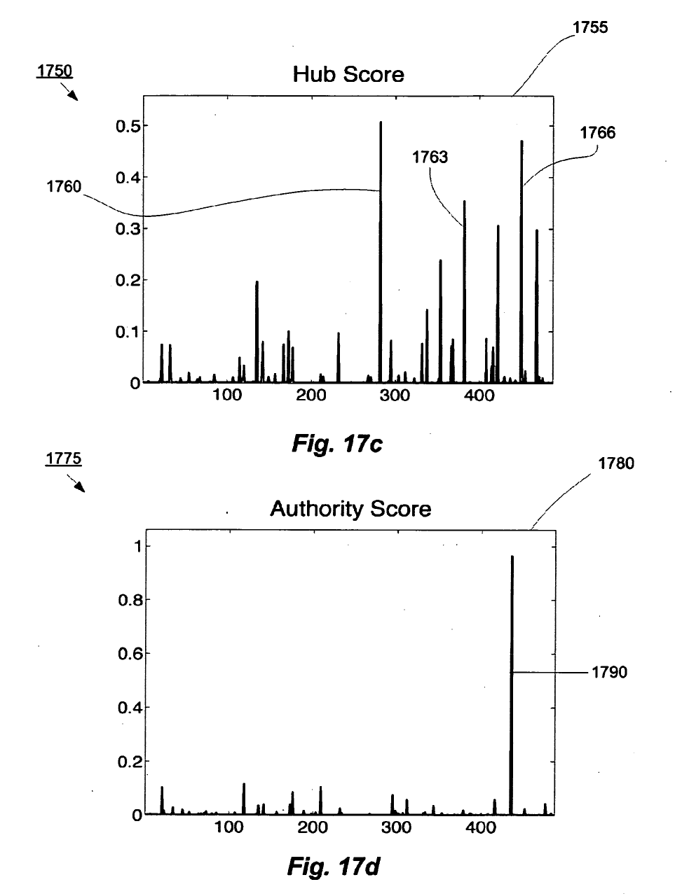

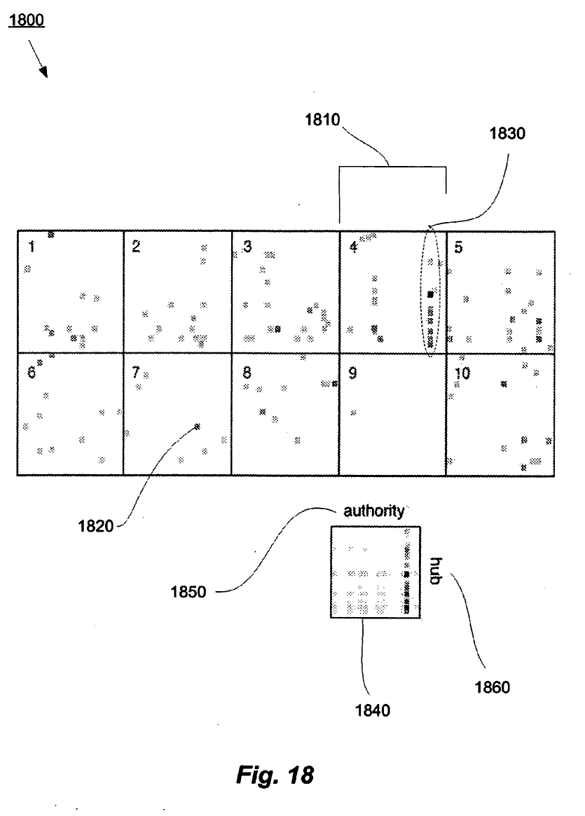

Experimental results using real data for structural eigen-trend analysis will now be considered for at least one embodiment of the present invention. In the experiments, structural eigen-trends extracted by using HOSVD generally comply with trends obtained by using other methods. Referring to FIGS. 17a-17d and 18, various graphs further illustrates results for the term or keyword “Technorati,” where Technorati is the name of a top blog search company. In the structural eigen-trend shown in FIG. 17b, there is a large spike 1730 at time 4 that is not in either the count-based trend 1720 or the scalar eigen-trend 1722 of the graph 1700 shown in FIG. 17a. All the entries that contain the term or keyword Technorati in the data set were manually checked. It turns out that many of these entries contain a line such as “Technorati Tag: news, music” at the bottom, to indicate the category of the entries. The crawler failed to remove this line from the body of the entries. As a result, the top authorities for the scalar eigen-trend 1722 are some blogs who posted a lot of entries that adopted Technorati tags, that includes peak 1710 (http://www.ratcliffeblog.com/), peak 1705 (http://www.emergencemarketing.com/), and peak 1715 (http://www.tomrafteryit.net/).

The dominating authority for the structural eigen-trend in graph 1725 of FIG. 17b shown as peak 1730 turns out to be the personal blog site of David Sifry, the founder and CEO of Technorati Inc. (http://www.sifry.com/alerts/). In the first week of August 2005 (which is the 4th week in the data set), David Sifry posted the first three parts of a study on the current state of the blogosphere. In this study, based on the data collected by the Technorati search engine, David Sifry presented a lot of statistics and insights about the blogosphere, including the growth of blog, the change of posting volume, and the trend of people adopting tags in their blogs. Because this was one of the most authoritative studies on the current state of the blogosphere, this study drew a lot of attention and generated intensive citations. This event is actually visually detectable from FIG. 18, which illustrates the adjacency matrices for the keyword-specific blog graph (on “Technorati”) in the first 10 weeks.

To find the reason for this spike, in FIG. 18 the adjacency matrices 1-10 for the two keywords over 10 weeks are depicted. Each rectangle (for example, 1810) represents the adjacency matrix for one week and each dot (for example, 1820) represents a non-zero element in the adjacency matrix which corresponds to a link between two blogs. The darker the dot, the larger the element value. As can be seen from the FIG. 18, in the 4th week 1810, other than the seemingly random dots, there is a distinct series of dots 1830 that represent many links pointing to a single blogger during that week. The blog by David Sifry is visualized at 1830. However, because of the large number of entries that contain Technorati (e.g., by using the Technorati Tag line), neither count-based trend 1720 nor scalar eigen-trend 1722 is able to detect this important event. In the method based on HOSVD, those blogs that incidentally contain Technorati do not form a well-structured community and therefore are treated more as noise. In contrast, the community formed by David Sifry's blog, as well as its followers, form a consistent community (David Sifry has continued posting a sequence of highly cited entries about Technorati in the following weeks). In the HOSVD-based method, this community visualized in FIG. 18 week 4 1840 stands out as the main community 1730 on Technorati and as shown in FIG. 17b, events within this community determine the main structural eigen-trend shown in graph 1725.

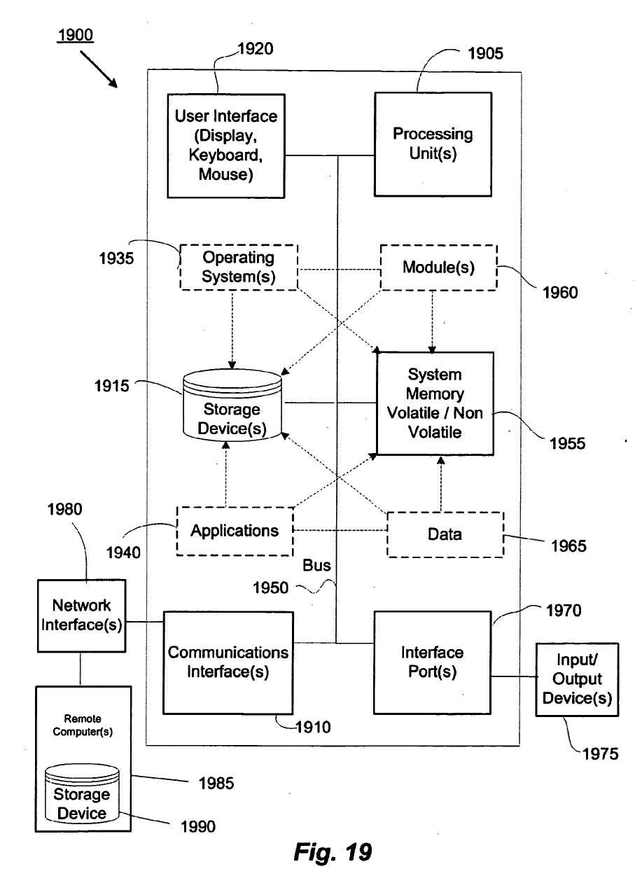

As noted earlier, in at least one embodiment, the system(s) and method(s) provided herein may be implemented using a computing device, for example, a personal computer, a server, a mini-mainframe computer, and/or a mainframe computer, etc., programmed to execute a sequence of instructions that configure the computer to perform operations as described herein. In various embodiments, the computing device may be, for example, a personal computer available from any number of commercial manufacturers such as, for example, Dell Computer of Austin, Tex., running, for example, the Windows™ XP™ and Linux operating systems, and having a standard set of peripheral devices (e.g., keyboard, mouse, display, printer). FIG. 19 is a functional block diagram of one embodiment of a computing device 1900 that may be useful for hosting software application programs implementing the system(s) and method(s) described herein. Referring now to FIG. 19, the computing device 1900 may include a processing unit 1905, communications interface(s) 1910, storage device(s) 1915, a user interface 1920, operating system(s) instructions 1935, application executable instructions/API 1940, all provided in functional communication and may use, for example, a data bus 1950. The computing device 1900 may also include system memory 1955, data and data executable code 1965, software modules 1960, and interface port(s). The Interface Port(s) 1970 may be coupled to one or more input/output device(s) 1975, such as printers, scanner(s), all-in-one printer/scanner/fax machines, etc. The processing unit(s) 1905 may be one or more microprocessor(s) or microcontroller(s) configured to execute software instructions implementing the functions described herein. Application executable instructions/APIs 1940 and operating system instructions 1935 may be stored using computing device 1900 on the storage device(s) 1915 and/or system memory 1955 that may include volatile and nonvolatile memory. Application executable instructions/APIs 1940 may include software application programs implementing the present invention system(s) and method(s). Operating system instructions 1935 may include software instructions operable to control basic operation and control of the processor 1905. In one embodiment, operating system instructions 1935 may include, for example, the XP™ operating system available from Microsoft Corporation of Redmond, Wash.

Instructions may be read into a main memory from another computer-readable medium, such as a storage device. The term “computer-readable medium” as used herein may refer to any medium that participates in providing instructions to the processing unit 1905 for execution. Such a medium may take many forms, including, but not limited to, non-volatile media, volatile media, and transmission media. Non-volatile media may include, for example, optical or magnetic disks, thumb or jump drives, and storage devices. Volatile media may include dynamic memory such as a main memory or cache memory. Transmission media may include coaxial cable, copper wire, and fiber optics, including the connections that comprise the bus 1950. Transmission media may also take the form of acoustic or light waves, such as those generated during Radio Frequency (RF) and Infrared (IR) data communications. Common forms of computer-readable media include, for example, floppy disk, a flexible disk, hard disk, magnetic tape, any other magnetic medium, Universal Serial Bus (USB) memory stick™, a CD-ROM, DVD, any other optical medium, a RAM, a ROM, a PROM, an EPROM, a Flash EPROM, any other memory chip or cartridge, a carrier wave as described hereinafter, or any other medium from which a computer can read.

Various forms of computer-readable media may be involved in carrying one or more sequences of one or more instructions to the processing unit(s) 1905 for execution. For example, the instructions may be initially borne on a magnetic disk of a remote computer(s) 1985 (e.g., a server, a PC, a mainframe, etc.). The remote computer(s) 1985 may load the instructions into its dynamic memory and send the instructions over a one or more network interface(s) 1980 using, for example, a telephone line connected to a modem, which may be an analog, digital, DSL or cable modem. The network may be, for example, the Internet, and Intranet, a peer-to-peer network, etc. The computing device 1900 may send messages and receive data, including program code(s), through a network of other computer(s) via the communications interface 1910, which may be coupled through network interface(s) 1980. A server may transmit a requested code for an application program through the Internet for a downloaded application. The received code may be executed by the processing unit(s) 1905 as it is received, and/or stored in a storage device 1915 or other non-volatile storage 1955 for later execution. In this manner, the computing device 1900 may obtain an application code in the form of a carrier wave.

The present system(s) and method(s) may reside on a single computing device or platform 1900, or on multiple computing devices 1900, or different applications may reside on separate computing devices 1900. Application executable instructions/APIs 1940 and operating system instructions 1935 may be loaded into one or more allocated code segments of computing device 1900 volatile memory for runtime execution. In one embodiment, computing device 1900 may include system memory 1955, such as 512 MB of volatile memory and 80 GB of nonvolatile memory storage. In at least one embodiment, software portions of the present invention system(s) and method(s) may be implemented using, for example, C programming language source code instructions. Other embodiments are possible.

Application executable instructions/APIs 1940 may include one or more application program interfaces (APIs). The system(s) and method(s) of the present invention may use APIs 1940 for inter-process communication and to request and return inter-application function calls. For example, an API may be provided in conjunction with a database 1965 in order to facilitate the development of, for example, SQL scripts useful to cause the database to perform particular data storage or retrieval operations in accordance with the instructions specified in the script(s). In general, APIs may be used to facilitate development of application programs which are programmed to accomplish some of the functions described herein.

The communications interface(s) 1910 may provide the computing device 1900 the capability to transmit and receive information over the Internet, including but not limited to electronic mail, HTML or XML pages, and file transfer capabilities. To this end, the communications interface 1910 may further include a web browser such as, but not limited to, Microsoft Internet Explorer™ provided by Microsoft Corporation. The user interface(s) 1920 may include a computer terminal display, keyboard, and mouse device. One or more Graphical User Interfaces (GUIs) also may be included to provide for display and manipulation of data contained in interactive HTML or XML pages.

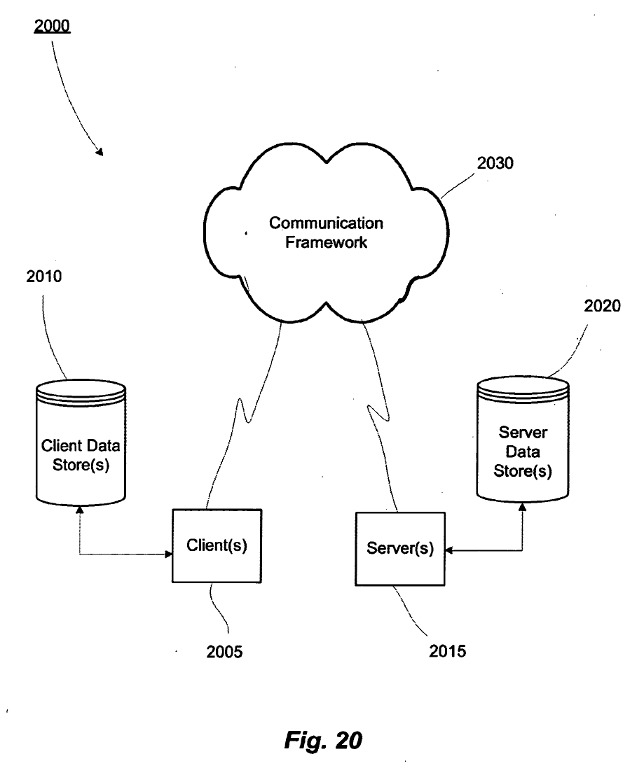

Referring now to FIG. 20, a network 2000 upon which the system(s) and method(s) may operate, is illustrated. As noted above, the system(s) and method(s) of the present patent application may be operational on one or more computer(s). The network 2000 may include one or more client(s) 2005 coupled to one or more client data store(s) 2010. The one or more client(s) may be coupled through a communication network (e.g., fiber optics, telephone lines, wireless, etc.) to the communication framework 2030. The communication framework 230 may be, for example, the Internet, and Intranet, a peer-to-peer network, a LAN, an ad hoc computer-to-computer network, etc. The network 2000 may also include one or more server(s) 2015 coupled to the communication framework 2030 and coupled to a server data store(s) 2020. The present invention system(s) and method(s) may also have portions that are operative on one or more of the components in the network 2000 so as to operate as a complete operative system(s) and method(s).

While embodiments of the invention have been described above, it is evident that many alternatives, modifications and variations will be apparent to those skilled in the art. In general, embodiments may relate to the automation of these and other business processes in which analysis of data is performed. Accordingly, the embodiments of the invention, as set forth above, are intended to be illustrative, and should not be construed as limitations on the scope of the invention. Various changes may be made without departing from the spirit and scope of the invention. Therefore, the scope of the present invention should be determined not by the embodiments illustrated above, but by the claims appended hereto and their legal equivalents.

All publications, patents, and patent applications cited herein are hereby incorporated by reference in their entirety for all purposes.

We claim:

1. A method of extracting and analyzing trends, comprising the steps of:
partitioning information obtained from one or more computers in a computer network into time windows;
building a feature vector to represent the distribution of a term used in a term search of one or more data source(s);
creating a matrix by arranging the feature vector(s) in the order of time;
applying a singular value decomposition (SVD) to the matrix; and
generating a temporal trend or generating a distribution vector, as to how the term changes with time among the one or more data source(s) from an output of the singular value decomposition (SVD).

2. The method of claim 1, wherein the step of generating is limited to generating a temporal trend as to how the term changes with time among the one or more data source(s) from an output of the singular value decomposition (SVD).

3. The method of claim 2, wherein the step of generating also includes generating a distribution vector as to how the term is distributed among the one or more data source(s) from an output of the singular value decomposition (SVD).

4. The method of claim 1, wherein the step of generating is limited to generating a distribution vector as to how the term is distributed among the one or more data source(s) from an output of the singular value decomposition (SVD).

5. The method of claim 3, wherein the information is dynamic data.

6. The method of claim 5 wherein the method captures the dominant characteristics of individual data source(s) from the one or more data source(s).

7. The method of claim 6, wherein the trend is a scalar eigen-trend that indicates the temporal trend of the popularity of the one or more data source(s) and indicates the relative contribution of one or more entity(ies) to the temporal trend.

8. The method of claim 7, wherein the distribution vector represents the authority of an entity(ies) that generates at least a portion of the data.

9. The method of claim 8, wherein the one or more data source(s) is a blog(s).

10. The method of claim 9, wherein the trend includes temporal indicators that take differences between individual blog(s) into consideration.

11. A method of extracting and analyzing trends, comprising the steps of:
partitioning information into time windows;
building a feature matrix to represent the distribution of a term used in a term search of one or more data source(s);
creating a three dimensional matrix by arranging a plurality of the feature matrix in the dimension of time;
applying a higher order singular value decomposition (HOSVD) to the three dimensional matrix; and
generating a trend or generating a distribution vector(s), as to how the term changes with time among the one or more data source(s) from an output of the higher order singular value decomposition (HOSVD).

12. The method of claim 11, wherein the step of generating a trend or generating a distribution vector(s) is limited to generating a trend as to how the term changes with time among the one or more data source(s) from an output of the higher order singular value decomposition (HOSVD).

13. The method of claim 12, wherein the step of generating a trend or generating a distribution vector(s) also includes generating a distribution vector(s) as to how the term is distributed among the one or more data source(s) from an output of the higher order singular value decomposition (HOSVD).

14. The method of claim 11, wherein the step of generating a trend or generating a distribution vector(s) is limited to generating a distribution vector(s) as to how the term is distributed among the one or more data source(s) from an output of the higher order singular value decomposition (HOSVD).

15. The method of claim 11, wherein an iterative method is used to generate one or more characteristic change indicator(s) including a trend vector, an authority vector, and a hub vector.

16. The method of claim 15, wherein the hub vector generates a hub score.

17. The method of claim 15, wherein the authority vector generates an authority score.

18. The method of claim 11, wherein the method captures a community that consists of hub and authority and tracks structure changes of the community over time.

19. The method of claim 11, wherein the method is applied to analyze dynamically changing data or dynamically changing graph structures.

20. The method of claim 11, wherein the method further includes the step of tracking relationship behavior to find constant hubs and authorities over time.

21. The method of claim 11, wherein the method includes a plurality of trends and the generation of a plurality of scores, indicative of the change in the graph structure.

22. The method of claim 11, wherein the one or more data source(s) is a blog(s).

23. A method of extracting and analyzing trends, comprising the steps of:
determining temporal pattern(s) for overall trend(s) of a plurality of blog(s); and
determining the contribution of one or more individual blogger(s) to the trend(s).

24. The method of claim 23, wherein the temporal pattern(s) are determined using a non-probabilistic approach.

25. The method of claim 24, wherein the non-probabilistic approach is based on singular value decomposition.

26. The method of claim 24, wherein the non-probabilistic approach is based on higher-order singular value decomposition.

27. A system for extracting and analyzing trends of dynamic data, comprising:
a vector time matrix module; and
a singular value decomposition module coupled to the vector time matrix module, wherein the system generates a temporal trend as to how a selected term changes with time among one or more data source(s) and generates a popularity distribution indicative of how the term is distributed among the one or more data source(s).

28. A system for extracting and analyzing trends of dynamic data, comprising:
an adjacency matrix-time tensor module; and
a higher order singular value decomposition module coupled to the adjacency matrix-time tensor module, wherein the system generates a trend as to how a selected term changes with time among one or more data source(s), generates a popularity distribution indicative of how the term is distributed among the one or more data source(s) and generates a hub score indicative of the constant linking of various data sources to the one or more data source(s).
